(19) United States
(12) Patent Application Publication
(10) Pub. No.: US 2007/0097162 A1
(43) Pub. Date: May 3, 2007

(54) Liquid ejection apparatus, liquid ejection method, and method for forming wiring pattern of circuit board

(75) Inventors: Hironobu Iwashita, Hino-shi (JP); Kazunori Yamamoto, Hino-shi (JP); Shigeru Nishio, Yamato-koriyama-shi (JP); Kazuhiro Murata, Tsukuba-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: KONICA MINOLTA HOLDINGS, INC., Tokyo (JP); SHARP KABUSHIKI KAISHA, Osaka (JP); NATIONAL INSTITUTE OF ADVANCED INDUSTRIAL SCIENCE & TECHNOLOLGY, Tokyo (JP)

(21) Appl. No.: 10/567,484

(22) PCT Filed: Jul. 29, 2004
(86) PCT No.: PCT/JP04/10828

§ 371 Date: Feb. 7, 2006

(30) Foreign Application Priority Data
Aug. 8, 2003 (JP) 2003-290544
Aug. 8, 2003 (JP) 2003-290612

(51) Int. Cl. B41J 29/38

(52) U.S. Cl. 347/9; 347/19

(57) ABSTRACT

A liquid ejection apparatus includes: a liquid ejection head (56) having a nozzle (51) for ejecting a droplet of charged solution from the tip portion; an ejection electrode (58) provided on the liquid ejection head, to which a voltage is applied for generating an electric field to eject the droplet; a voltage applying unit (35) for applying the voltage to the ejection electrode; a substrate K including insulative material for receiving the ejected droplet; and an ejection atmosphere adjusting unit (70) for keeping an atmosphere subject to ejection from the liquid ejection head, to a dew point of 9 degrees centigrade or more and less than a water saturation temperature.

### FIELD OF THE INVENTION

The invention relates to a liquid ejection apparatus that ejects liquid on a substrate, a liquid ejection method, and method for forming wiring patterns of a circuit board.

### DESCRIPTION OF THE BACKGROUND

There has been known an electrostatic attraction type inkjet printer as described in patent publication 1. This type of inkjet printer includes a plurality of convex ink guides, each guide ejecting ink from the tip portion, opposing electrodes arranged and grounded, opposing to respective tips of the ink guides, and ejection electrodes for applying ejection voltage to ink for each ink guide. Additionally, two kinds of convex ink guides are prepared, each guide having a different width of slit that guides the ink, and selective use of these guides permits the convex ink guide to eject two sizes of droplets.

This conventional inkjet printer applies pulse voltage to the ejection electrodes to eject ink droplets, and guides the ink droplets toward the opposing electrode side by an electric field produced between the ejection electrode and the opposing electrode.

In the above-described inkjet printer in which the ink is charged and ejected by electrostatic attraction force of an electric field, in a case where the ink is ejected onto a substrate having an image receiving layer made of synthetic silica that is insulative, the charge, which is carried by previously ejected ink droplets adhered on the substrate, is not released. This charge generates repulsive force between the previously adhered droplets and newly ejected ink droplets, scattering the ink droplets around. Therefore, the ink droplets do not reach predetermined positions. This causes problems such as reduction of resolution and spattering phenomenon, the surroundings being made dirty by scattered ink.

In order to solve these problems, a prior art technology (see, for example, patent document 2) is disclosed, in which the charge carried by ink droplets is released in a stepwise manner by reducing surface resistance of a substrate to restrain the continuously reaching ink droplets from being scattered by an electric field, by using a substrate having an ink receiving layer or supporting member that contains a tetra-ammonium salt type conductive agent and has a surface resistance of 9×10¹¹ Ω or less at 20 degrees centigrade and 30% RH.

There is also disclosed a prior art technology (see, for example, patent document 3) in which the charge carried by ink droplets is released in a stepwise manner from a conductive layer of a support member to restrain the continuously reaching ink droplets from being scattered by an electric field, by using a support member made of a resin sheet or a resin-coated sheet, the support member having an upper face conductive part, a lower face conductive part, and a side face conductive part at the upper face, lower face, and side face or the support member, respectively. Here, the upper face conductive layer is provided with an image receiving layer, and each conductive layer has an intrinsic surface resistance of 1×10¹⁰ Ω/cm² or less, and a thickness of 0.1-20 μm.

There has been also known a conventional inkjet printer using electrostatic attraction force as described in patent documents 4, 5, 6, and 7. Each of these inkjet printers has ejection electrodes in a head that ejects ink, and grounded opposing electrodes that are oppositely arranged at positions away from the head in a predetermined distance. A recording medium, such as a paper sheet, is transported into the space between the opposing electrodes and the head. By applying voltage to the ejection electrode, ink is charged and ejected from the head toward the opposing electrode.

Patent document 1: JP H11-277747 A (FIGS. 2 and 3);

Patent document 2: JP S58-177390 A;

Patent document 3: JP 2000-242024 A;

Patent document 4: JP H08-238774 A;

Patent document 5: JP 2000-127410 A;

Patent document 6: JP H11-198383 A;

Patent document 7: JP H10-278274 A.

### DISCLOSURE OF THE INVENTION

### Problems to be Solved by the Invention

However, in the prior art technologies described above, in case of making ejected droplets minute, since the electric field is affected by surface conditions of the substrate, the size of droplet is not stable for example, and therefore a problem arises that normal ejection of ink can not be attained stably.

That is, in the inkjet printer described in patent document 1, as mentioned above, a problem arises when ink is ejected onto the insulative substrate, that positional accuracy of deposition is reduced and the size of droplets is not stable due to repulsive force produced by the charge of previously adhered ink droplets.

In the substrate described in patent document 2 and the support member described in patent document 3, the resistance of surface to which droplets adhere has been reduced, however, the effect is not sufficient enough for minute droplets that are particularly susceptible to the electric field, therefore next droplets are affected by previously reached droplets and scattered around, which causes a problem of reduction in accuracy of landing position.

Further, the moisture content of the ink receiving layer of the substrate or the conductive layer of the support member changes due to the change in environment at the time of ejection, resulting in change in conductivity of the support member. This lead to a problem that accuracy of landing position cannot be maintained stably, due to the environmental change.

This inferior accuracy of landing position not only decreases quality of printed images but also causes serious problem, for example, particularly when drawing wiring patterns of a circuit using conductive ink based on inkjet technology. That is, inferior accuracy of position causes the wiring not to be drawn in desired width and sometimes even to result in breakage or short-out of the circuit.

Additionally, since an ejected amount of next droplet varies and is unstable due to the influence from previously reached droplets, the size of formed dot diameter becomes also unstable.

Further, in the inkjet printer disclosed in patent documents 4-7, since opposing electrodes are arranged oppositely to the head, the electric field is affected by thickness and/or type of material of a recording medium, and the ejected amount of ink is sometimes not uniform, therefore ink dot-diameters sometimes vary within positions. In order to solve this problem, a conductive recording medium may be used as the opposing electrode, however, this is not applicable to an insulative recording medium.

Therefore, regarding each described invention, an object is to stably eject a constant amount of droplet, particularly even in case of ejecting minute droplets.

### MEANS OF SOLVING THE PROBLEMS

The problem is solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; a voltage applying unit for applying the voltage to the ejection electrode; a substrate including insulative material for receiving the ejected droplet; and an ejection atmosphere adjusting unit for keeping an atmosphere subject to ejection from the liquid ejection head, to a dew point of 9 degrees centigrade or more and less than a water saturation temperature.

Alternatively, the problem is solved by a liquid ejection method of a liquid ejection apparatus including a liquid ejection head having a nozzle for ejecting a droplet of charged solution from the tip portion, an ejection electrode provided on the liquid ejection head applied with a voltage for generating an electric field to eject the droplet, and voltage applying unit for applying the voltage to the ejection electrode, comprising the step of: ejecting the droplet toward a substrate including insulative material in an atmosphere which is kept to a dew point of 9 degrees centigrade or more and less than a water saturation temperature.

An electric field of the substrate surface has influence on the electric field intensity, which concentrates at the tip of the nozzle to fly a droplet. Variation of electric field intensity between the nozzle and the substrate results in change in electrostatic force that overcomes the surface tension of the solution surface at the nozzle tip, which causes variation of ejection quantity and critical voltage. In the case where the substrate is insulative, the critical voltage changes according to absolute humidity. Here, the absolute humidity is a ratio of mass of vapor to gas excluding the vapor (dry air), and is also called mixing ratio.

Accordingly, bringing the absolute humidity to 0.007 kg/kg or more (preferably to 0.01 kg/kg or more), that is, bringing a dew point to 9 degrees centigrade or more (preferably to 14 degrees centigrade or more) under an atmospheric pressure accelerates leakage of charge from the substrate surface to the air, and suppresses the influence of electric field of the substrate surface.

Meanwhile, a “dew point” is a temperature at which moisture in gas reaches a saturated state and condenses into dew.

A “substrate” is an object which receives landing of an ejected droplet of solution. For example, when technology of ejecting solution is applied to an inkjet printer, a recording medium, such as a paper or a sheet, corresponds to a substrate, and in case of forming a circuit with conductive paste, a board used as a base on which the circuit is to be formed corresponds to a substrate.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; voltage applying unit for applying the voltage to the ejection electrode; and a substrate including insulative material having a surface resistance of 10⁹ Ω/cm² or less at least at the area to receive ejected droplets.

Alternatively, the problem is solved by a liquid ejection method of a liquid ejection apparatus including a liquid ejection head having a nozzle for ejecting a droplet of charged solution from the tip portion, an ejection electrode provided on the liquid ejection head applied with a voltage for generating an electric field to eject the droplet, and voltage applying unit for applying the voltage to the ejection electrode, comprising the step of: ejecting the droplet toward a substrate including insulative material having a surface resistance 10⁹ Ω/cm² or less at least at the area to receive ejected droplets.

That is, by bringing the surface resistance of the substrate to 10⁹ Ω/cm² or less, leakage of charge from the substrate surface to the air is accelerated to suppress the influence of electric field from the substrate surface.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; voltage applying unit for applying the voltage to the ejection electrode; and a substrate including insulative material provided with a surface treatment layer making a surface resistance 10⁹ Ω/cm² or less at least at the area to receive ejected droplets.

Alternatively, the problem is solved by a liquid ejection method of a liquid ejection apparatus including a liquid ejection head having a nozzle for ejecting a droplet of charged solution from the tip portion, an ejection electrode provided on the liquid ejection head applied with a voltage for generating an electric field to eject the droplet, and voltage applying unit for applying the voltage to the ejection electrode, comprising the step of: ejecting the droplet toward a substrate including insulative material provided with a surface treatment layer making a surface resistance 10⁹ Ω/cm² or less at least at the area to receive ejected droplets.

That is, by providing the substrate with a surface treatment layer making a surface resistance of 10⁹ Ω/cm² or less, leakage of charge from the substrate surface is accelerated and the influence of electric field from the substrate surface is suppressed.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; voltage applying unit for applying the voltage to the ejection electrode; and a substrate including insulative material provided with a surface treatment layer formed by coating of a surface active agent at least at the area to receive ejected droplets.

Alternatively, the problem is solved by a liquid ejection method of a liquid ejection apparatus including a liquid ejection head having a nozzle for ejecting a droplet of charged solution from the tip portion, an ejection electrode provided on the liquid ejection head applied with a voltage for generating an electric field to eject the droplet, and voltage applying unit for applying the voltage to the ejection electrode, comprising the step of: ejecting the droplet toward a substrate including insulative material provided with a surface treatment layer formed by coating of a surface active agent at least at the area to receive ejected droplets.

That is, formation of the surface treatment layer by coating a surface active agent on the substrate allows reduction of the surface resistance, which accelerates leakage of charge from the substrate surface and suppresses the influence of electric field of the substrate surface.

Additionally, the problem can be solved by a liquid ejection method comprising the steps of: forming a surface treatment layer on a substrate including insulative material, by coating a surface active agent at least at the area to receive ejected droplets; ejecting the droplets onto the surface treatment layer of the substrate from the tip of the nozzle, by applying an ejection voltage to solution inside a nozzle; and removing the surface treatment layer except for the portions which the droplets adhered, after the ejected droplets are dried and solidified.

That is, the surface resistance is reduced, leakage of charge from the substrate surface is accelerated, and the influence of electric field from the substrate surface is suppressed. Further, the surface treatment layer is removed except for the portions which the droplets landed, thus prevents occurrence of leakage caused by reduction of surface resistance by the surface active agent.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; and a voltage applying unit for applying the voltage of a signal waveform to the ejection electrode, a voltage value of the signal waveform at least partly satisfying Vₛ (V) of the following expression (A), where a maximum value of surface potentials of an insulative substrate that receives the ejected droplets, is represented by Vₘₐₓ (V), and a minimum value of the same by Vₘᵢₙ (V).

Alternatively, the problem can be solved by a liquid ejection method of a liquid ejection apparatus including a liquid ejection head having a nozzle for ejecting a droplet of charged solution from the tip portion, an ejection electrode provided on the liquid ejection head applied with a voltage for generating an electric field to eject the droplet, and voltage applying unit for applying the voltage to the ejection electrode, comprising the step of: applying the voltage of a signal waveform to the ejection electrode, a voltage value of the signal waveform at least partly satisfying Vₛ (V) of the following expression (A), where a maximum value of surface potentials of an insulative substrate that receives the ejected droplets, is represented by Vₘₐₓ (V), and a minimum value of the same by Vₘᵢₙ (V).

The aforementioned liquid ejection method preferably comprises the steps of measuring the surface potentials of the insulative substrate before applying the voltage to the ejection electrode; and obtaining the maximum value Vₘₐₓ (V) and the minimum value Vₘᵢₙ (V).

[Equation 1]
Vₛ≦V_{mid}V_{|max-min|}, V_{mid}+V_{|max-min|}≦Vₛ (A)

Here, V_{|max-min|} (V) is defined by the following equation (B), and V_{mid} (V) by equation (C).
V_{|max-min|}=|Vₘₐₓ−Vₘᵢₙ| (B)
V_{mid}=(Vₘₐₓ+Vₘᵢₙ)/2 (C)

As mentioned above, when the voltage of the signal waveform outputted to the ejection electrode at least satisfies Vₛ in a part, influence of the surface potential at an arbitrary position on the surface of the insulative substrate is made smaller, which allows the electric field for ejection to be almost uniform.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; a detecting unit for detecting surface potentials of an insulative substrate that receives the ejected droplets; and a voltage applying unit for applying the voltage of a signal waveform, a voltage value of the signal waveform at least partly satisfying Vₛ (V) of the aforementioned expression (A), where a maximum value of surface potentials of an insulative substrate detected by the detecting unit, is represented by Vₘₐₓ (V), and a minimum value of the same by Vₘᵢₙ (V).

In the liquid ejection apparatus described above, the detecting unit detects the surface potentials of the insulative substrate, and from this detection, the maximum value Vₘₐₓ (V) and the minimum value Vₘᵢₙ (V) are obtained. Based on these values, the voltage applying unit applies the voltage of a signal waveform, a value of the voltage at least partly satisfying Vₛ (V) of expression (A) presented above.

This makes the influence from the surface potential at an arbitrary position on the surface of the insulative substrate smaller, which allows the electric field for ejection to be almost uniform.

Additionally, a voltage of a signal waveform that keeps a constant potential, satisfying Vₛ of aforementioned expression (A) may be applied to the ejection electrode.

Even when the voltage applied to the ejection electrode is a signal waveform that keeps a constant potential, influence of the surface potential at an arbitrary position on the surface of the insulative substrate is made smaller, which allows the electric field for ejection to be almost uniform.

Here, the absolute value of the constant voltage is preferably 5 times or larger to V_{|max-min|}, and more preferably, 10 times or larger.

Additionally, a voltage of a signal waveform of a pulse voltage satisfying VS of aforementioned expression (A) may be applied to the ejection electrode.

In this case, it is preferable that the maximum value of the pulse voltage applied to the ejection electrode is larger than V_{mid} and the minimum value of the pulse voltage is smaller than V_{mid}.

In the above-described case, such a condition may be preferably satisfied that, within the differences, a difference between the maximum value of the pulse voltage and V_{mid}, and a difference between V_{mid} and the minimum value of the pulse voltage, one of them is larger than the other.

Even when the voltage applied to the ejection electrode is a signal waveform of a pulse voltage, influence of the surface potential at an arbitrary position on the surface of the insulative substrate is made smaller, which allows the electric field for ejection to be almost uniform.

Here, either the absolute value of the maximum value of the pulse voltage or the absolute value of the minimum value is preferably 5 times or larger to V_{|max-min|}, and more preferably, 10 times or larger.

Additionally, the problem can be solved by a liquid ejection apparatus comprising: a liquid ejection head having a nozzle for ejecting a droplet of charged solution from the tip portion; an ejection electrode provided on the liquid ejection head, to which a voltage is applied for generating an electric field to eject the droplet; a voltage applying unit for applying the voltage to the ejection electrode; and a static eliminator arranged oppositely to an insulative substrate that receives the ejected droplet, for discharging the insulative substrate.

Alternatively, the problem can be solved by a liquid ejection method of a liquid ejection apparatus including a liquid ejection head having a nozzle for ejecting a droplet of charged solution from the tip portion, an ejection electrode provided on the liquid ejection head, to which a voltage is applied for generating an electric field to eject the droplet, and voltage applying unit for applying the voltage to the ejection electrode, comprising the step of: discharging an insulative substrate before ejecting the droplet by application of the ejecting voltage to the ejection electrode.

By discharging the surface of the insulative substrate, the surface potential of the insulative substrate is made smaller, and also allows variation of the surface potential of the insulative substrate to be uniform.

As the static eliminator, a discharging electrode, which is arranged oppositely to the insulative substrate that receives ejected droplets, may be used, and be applied with an AC voltage. Further, this discharging electrode can be shared with the ejection electrode.

By applying an AC voltage to the discharging electrode opposing the insulative substrate, the surface of the insulative substrate can be discharged, which makes the surface potential of the insulative substrate smaller, and allows variation of the surface potential of the insulative substrate to be uniform.

As the static eliminator, a corona discharge type static eliminator, or a static eliminator in which light is irradiated to the insulative substrate, can be used.

Here, there is no particular limitations regarding wavelength of the light used in the static eliminator, as long as irradiation of the light can discharge, however, soft X-rays, ultraviolet rays or a (alpha) rays are preferable.

The inner diameter of a nozzle in the liquid ejection head is preferably 20 μm or less. With this, electric-field intensity distribution becomes narrow so that the electric field can be concentrated. As a result, a formed droplet can be minute and stabilized in the shape. A droplet, immediately after ejection from the nozzle, is accelerated by electrostatic force between the electric field and the charge. The electric field sharply declines as the droplet flies apart from the nozzle, and its speed is decreased by air resistance. However, the minute droplet having concentrated electric field, as it comes close to the substrate, is attracted by reversely polarized charge induced at the substrate side. This allows the droplet to land on the substrate, even in case the droplet is minute.

On the other hand, making the droplet minute results in electric-field concentration, but in case electric-field distribution of the surface of the substrate is not uniform, as the droplet becomes minute, it is susceptible to be influenced from the electric field that varies depending on the surface condition of the substrate.

However, according to the various inventions described above, since influence of uneven electric field is suppressed, ejection stability droplet could be improved more effectively and remarkably when the droplet is minute.

The inner diameter of the nozzle is preferably 8 μm or less. By setting the nozzle diameter to 8 μm or less, the electric field can be more concentrated, the droplet can be made more minute, and influence on electric field intensity distribution caused by variation of distance to the opposing electrode can be reduced at the time of flying. Accordingly, influences of positional precision of the opposing electrode, characteristics or thickness of the substrate, toward the droplet shape and landing precision can be reduced.

In addition, by enhancing the electric field concentration, the influence of electric-field crosstalk, which is a problem in case of making nozzle density higher for multiple nozzle arrangement, can be reduced and higher nozzle density can be achieved.

Further, setting the inner diameter of a nozzle to 4 μm or less allows remarkable electric field concentration, the maximum electric field intensity to be higher, the droplet to have a stable shape and to be extremely minute, and initial ejection speed of droplet to be faster. This allows the flying stability to be improved, thereby further improves landing precision and ejecting response.

Further, by enhancing the electric field concentration, the influence of electric-field crosstalk, which is a problem in case of making nozzle density higher for multiple nozzle arrangement, is seldom effective, and even higher nozzle density can be achieved.

In the structure described above, the inner diameter of the nozzle is preferably 0.2 μm or larger. By setting the inner diameter of a nozzle to 0.2 μm or larger, charging efficiency of a droplet can be improved, and ejection stability of droplets can be improved.

Hereinafter, in the description, “inner diameter of nozzle” is also referred to as “nozzle diameter”, indicating the inner diameter of the nozzle at the tip portion to eject a droplet. A cross-section of a liquid-ejection opening of a nozzle is not limited to a round shape. For example, when the cross-section of a liquid-ejection opening has a polygon, star, or other shape, the “inner diameter” indicates a diameter of a circumscribed circle of the cross-sectional shape. Concerning a “nozzle diameter”, “inner diameter at the tip portion of a nozzle”, or in case there is other numerical limitation, it is similarly indicated. A “nozzle radius” indicates ½ length of the nozzle diameter (inner diameter at the tip portion of the nozzle).

Further, concerning the aforementioned liquid ejection apparatus,

(1) It is preferable that the nozzle is formed of insulative material, and an ejection voltage applying electrode is inserted inside of the nozzle, or plating is applied to the inside of the nozzle so as to function as the electrode.

(2) In the structure described in each of the aforementioned inventions or in the aforementioned structure of (1), it is preferable that the nozzle is formed of insulative material and the electrode is inserted or plating is applied inside the nozzle so as to function as the electrode, as well as an electrode for ejection is also provided outside the nozzle.

As for the electrode for ejection outside the nozzle, it is provided for example, in circumference of the edge at the nozzle tip portion, whole side surface at the nozzle tip portion, or partly in the side surface at the nozzle tip portion.
(3) In the structure described in each of the aforementioned inventions, or in the aforementioned structure of (1) or (2), a voltage V applied to the nozzle for driving is preferably in a range presented in the following expression:

$$h \sqrt{\frac{γ π}{{ɛ}_{0} d}} > V > \sqrt{\frac{λ k d}{2 {ɛ}_{0}}} \qquad ( 1 )$$

where γ: surface tension of solution (N/m), ∈₀: permittivity of vacuum (F/m), d: nozzle diameter (m), h: distance between nozzle and substrate (m), k: proportional constant depending on nozzle shape (1.5<k<8.5).
(4) In the structure described in each of the aforementioned inventions, or in the aforementioned structure of (1), (2) or (3), applied arbitrary signal waveform of voltage is preferably 1,000 V or less.

By setting an upper limitation value of the ejection voltage as above, ejection control can be made easier, and improvement of accuracy by improvement of durability of the apparatus and implementation of safety measures can be easily attained. (5) In the structure described in each of the aforementioned inventions, or in the aforementioned structure of (1), (2), (3) or (4), applied ejection voltage is preferably 500 V or less.

By setting an upper limitation value of the ejection voltage as above, ejection control can be easier, and further improvement of accuracy by further improvement of durability of the apparatus and implementation of safety measures can be easily attained.

(6) In the structure described in each of the aforementioned inventions, or any one of aforementioned (1) to (5), the distance between the nozzle and the substrate is preferably 500 μm or less to obtain high landing precision with minute nozzle diameter.

(7) In the structure described in each of the aforementioned inventions, or any one of aforementioned (1) to (6), it is preferable to apply a pressure to the solution inside the nozzle.

(8) In the structure described in each of the aforementioned inventions, or any one of aforementioned (1) to (7), in case of ejection by a single pulse, a pulse width Δt not less than a time constant τ determined by the following equation is preferably applied.
τ=∈/σ (2)
where ∈: permittivity of solution (F/m), σ: conductivity of solution (S/m).

Further, it can be applied to formation of a wiring pattern of a circuit board by ejecting metal paste using any one of liquid ejection methods described above.

In this case, it is preferable that the surfactant is removed after formation of the wiring pattern. This prevents a short circuit caused by reduction of surface resistance due to the surfactant.

### EFFECTS OF THE INVENTION

When atmosphere for ejecting droplets is maintained to a dew point of 9 degrees centigrade or more and less than a saturation temperature, absolute humidity becomes 0.007 kg/kg or more. This atmosphere accelerates leakage of charge from the substrate surface effectively even when the substrate is insulative, and suppresses the influence of electric field at the substrate surface, so that positional precision of landed droplets is improved, and variation in the size of ejected droplets and landing dot diameters is also suppressed, thus achieving stability.

Additionally, keeping the atmosphere less than a saturation temperature prevents dew formation on the ejection head and the substrate.

In case that the substrate surface has a surface resistance of 10⁹ Ω/cm² or less at least at the area to receive ejected droplets, in case that the substrate surface is provided with a surface treating layer having a surface resistance of 10⁹ Ω/cm² or less at least at the area to receive ejected droplets, or in case that the substrate surface has a surface treating layer formed by coating a surfactant at least at the area to receive ejected droplets, leakage of charge from the substrate surface can be effectively performed, positional precision of landed droplets is improved, and variation in the size of ejected droplets and landing dot diameters is also suppressed, thus achieving stability.

In a liquid ejection method in which the substrate surface is coated by a surfactant in advance before receiving ejected droplets, the surface resistance of the substrate is reduced and leakage of charge from the substrate is accelerated, so that influence of electric field at the substrate surface is suppressed.

When the surface treatment layer is removed except the portions where the droplets land, it is possible to prevent occurrence of leakage caused by reduction of surface resistance by the surfactant. It is also possible to avoid inconvenience, in case inconvenience occurs at later process or at later use of the substrate when the surfactant adheres.

Particularly, when the liquid ejection method using the above-described structure is applied to the formation of wiring pattern of a circuit board, droplets of metal paste are deposited along a desired wiring pattern, and then the surfactant is removed after formation of the wiring pattern, thus portions except the wiring pattern have high insulation properties so that fine and high density of wiring patterns can be formed without occurrence of a short circuit or the like.

When a voltage of a signal waveform satisfying Vₛ (V) of the previously presented expression (A) is applied to the ejection electrode, surface potentials of the insulative substrate hardly influences the value of electric field for ejection, which allows an amount of liquid ejected from the ejection opening to be uniform even when the substrate receiving the ejected droplets is an insulative substrate.

The surface potentials of the insulative substrate can be made uniform by discharging the surface of the insulative substrate, and therefore an amount of liquid ejected from the ejection opening can be made uniform even when the substrate receiving the ejected droplets is an insulative substrate.

In this case, by using the ejection electrode also as a discharging electrode, the structure of a liquid ejection apparatus can be simplified.

By making a nozzle diameter of a liquid ejection head minute, electric field intensity distribution can be made narrower, allowing the electric field to be concentrated. As a result, the formed droplet can be minute, its shape can be stabilized, and total voltage applied can be reduced.

While minute droplets are susceptible to uneven surface potentials at the substrate side, each structure described above can suppress the influence. Accordingly, stable ejection can be achieved for minute droplets.

### BRIEF DESCRIPTION OF THE DRAWINGS

FIG. 1A shows an electric field intensity distribution when nozzle diameter is φ0.2 μm and distance between the nozzle and an opposing electrode is set to 2000 μm.

FIG. 1B shows an electric field intensity distribution when the nozzle diameter is φ0.2 μm and the distance between the nozzle and the opposing electrode is set to 100 μm.

FIG. 2A shows an electric field intensity distribution when the nozzle diameter is φ0.4 μm and the distance between the nozzle and the opposing electrode is set to 2000 μm.

FIG. 2B shows an electric field intensity distribution when the nozzle diameter is φ0.4 μm and the distance between the nozzle and the opposing electrode is set to 100 μm.

FIG. 3A shows an electric field intensity distribution when the nozzle diameter is φ1 μm and the distance between the nozzle and the opposing electrode is set to 2000 μm.

FIG. 3B shows an electric field intensity distribution when the nozzle diameter is φ1 μm and the distance between the nozzle and the opposing electrode is set to 100 μm.

FIG. 4A shows an electric field intensity distribution when the nozzle diameter is φ8 μm and the distance between the nozzle and the opposing electrode is set to 2000 μm.

FIG. 4B shows an electric field intensity distribution when the nozzle diameter is φ8 μm and the distance between the nozzle and the opposing electrode is set to 100 μm.

FIG. 5A shows an electric field intensity distribution when the nozzle diameter is φ20 μm and the distance between the nozzle and the opposing electrode is set to 2000 μm.

FIG. 5B shows an electric field intensity distribution when the nozzle diameter is φ20 μm and the distance between the nozzle and the opposing electrode is set to 100 μm.

FIG. 6A shows an electric field intensity distribution when the nozzle diameter is φ50 μm and the distance between the nozzle and the opposing electrode is set to 2000 μm.

FIG. 6B shows an electric field intensity distribution when the nozzle diameter is φ50 μm and the distance between the nozzle and the opposing electrode is set to 100 μm.

FIG. 7 is a chart showing maximum electric field intensity under each condition of FIGS. 1A to 6B.

FIG. 8 is a diagram showing the relationship between the nozzle diameter of the nozzle and the maximum electric field intensity at a meniscus portion in the nozzle.

FIG. 9 is a diagram showing the relationship with the nozzle diameter of the nozzle, ejection starting voltage at which a droplet to be ejected at the meniscus portion starts flying, Rayleigh marginal voltage of the initial ejected droplet, and a ratio of the ejection starting voltage to the Rayreigh marginal voltage in the nozzle.

FIG. 10A is a graph showing the relationship between the nozzle diameter and a strong electric field area at the tip portion of the nozzle.

FIG. 10B is an enlarged graph showing an area corresponding to the small nozzle diameter in FIG. 10A.

FIG. 11 is a block diagram showing a schematic structure of a liquid ejection apparatus.

FIG. 12 is a cross-sectional view of a liquid ejection mechanism taken along a nozzle.

FIG. 13A illustrates the relationship with a voltage applied to solution, showing a state of non-ejection.

FIG. 13B illustrates the relationship with a voltage applied to the solution, showing a state of ejection.

FIG. 14A is a cross-sectional view partially cut to show another example of a shape of a flow passage inside the nozzle, the passage being rounded at a solution-chamber side.

FIG. 14B is a cross-sectional view partially cut to show another example of a shape of the flow passage inside the nozzle, the passage having a tapered circumferential surface at the inside wall.

FIG. 14C is a cross-sectional view partially cut to show another example of a shape of the flow passage inside the nozzle, the passage having a combination of a tapered circumferential surface and a linear flow passage.

FIG. 15 is a diagram showing the relationship between an absolute humidity and a dew point.

FIG. 16 is a chart showing the relationship between the absolute humidity and the dew point.

FIG. 17 is a diagram showing the relationship between a relative humidity and a dew point.

FIG. 18 is a cross-sectional view partially cut to show a liquid ejection mechanism according to a second embodiment of the present invention.

FIG. 19A is a graph showing a waveform of a steady voltage.

FIG. 19B is a graph showing a waveform of another steady voltage.

FIG. 20 is a cross-sectional view partially cut to show a liquid ejection mechanism according to a third embodiment of the present invention.

FIG. 21A is a graph showing a waveform of a pulse voltage.

FIG. 21B is a graph showing a waveform of another pulse voltage.

FIG. 22A is a graph showing a waveform of a pulse voltage.

FIG. 22B is a graph showing a waveform of another pulse voltage.

FIG. 23A is a graph showing a waveform of a pulse voltage.

FIG. 23B is a graph showing a waveform of another pulse voltage.

FIG. 24 is a cross-sectional view partially cut to show a liquid ejection mechanism according to a fourth embodiment of the present invention.

FIG. 25 is a cross-sectional view partially cut to show a liquid ejection mechanism according to a fifth embodiment of the present invention.

FIG. 26 is a cross-sectional view partially cut to show a liquid ejection mechanism according to a sixth embodiment of the present invention.

FIG. 27 is a chart showing the relationship between surface resistance of a substrate and deviation rate for dispersion of deposited diameters of droplets.

FIG. 28 is a chart showing the relationship among a dew point, surface-potential distribution of a substrate, ejection voltage, and deviation rate for dispersion of deposited diameters of droplets.

FIG. 29 is a chart showing the relationship between a bias voltage and a pulse voltage, and dispersion of deposited-droplet diameters under a good dew-point environment.

FIG. 30 is a view shown for explaining calculation of electric field intensity according to an embodiment of the invention.

FIG. 31 is a sectional side view showing one example of a liquid ejection mechanism of the invention.

FIG. 32 is a chart explaining ejection conditions based on distance-voltage relationship in the liquid ejection apparatus according to an embodiment of the invention.

### PREFERRED EMBODIMENT OF THE INVENTION

Preferred embodiments to implement the present invention will be explained below with reference to drawings. Embodiments described below have various limitations technically preferable for implementing the invention, but the scope of the invention is not limited to the following embodiments and exemplified drawings.

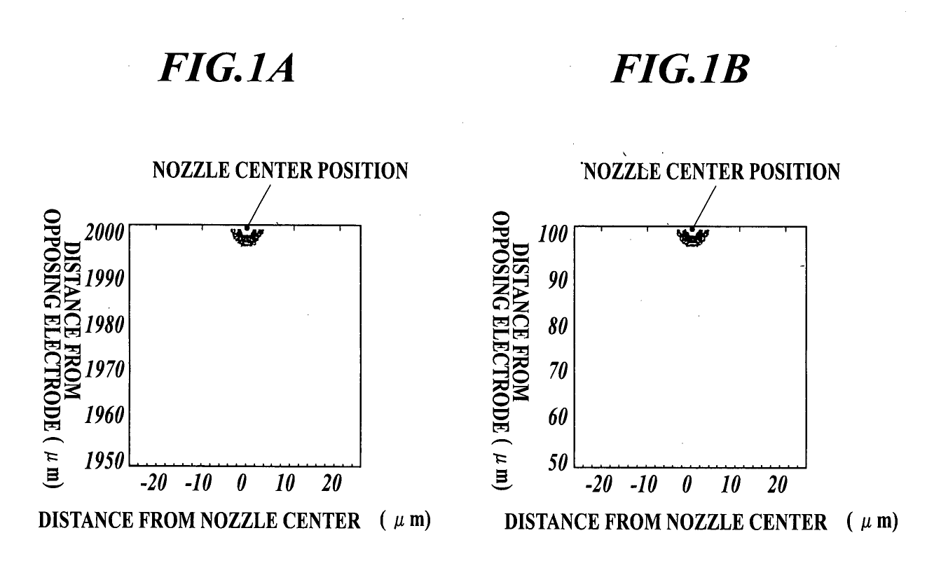

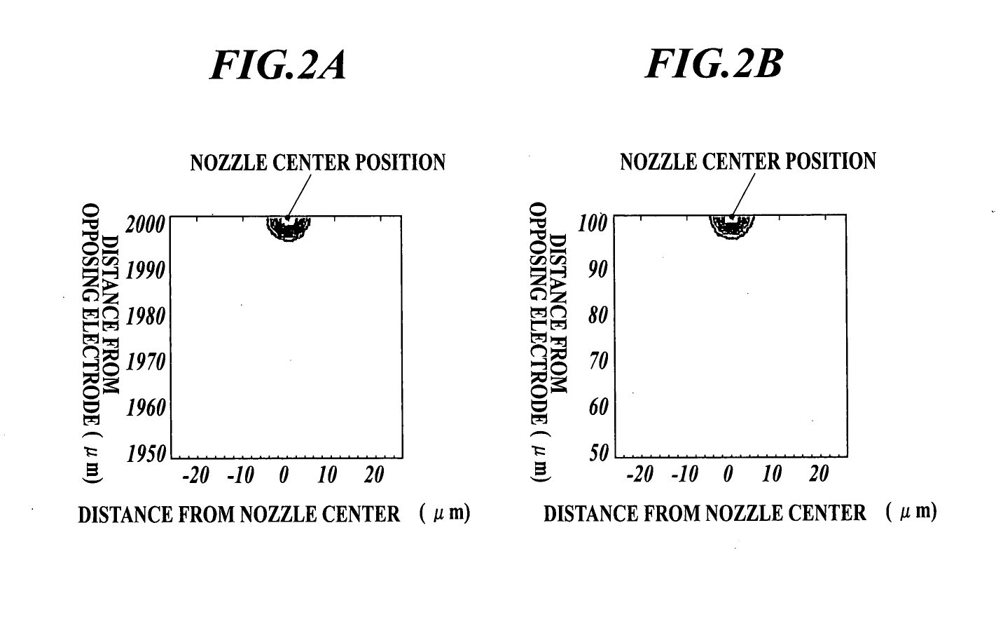

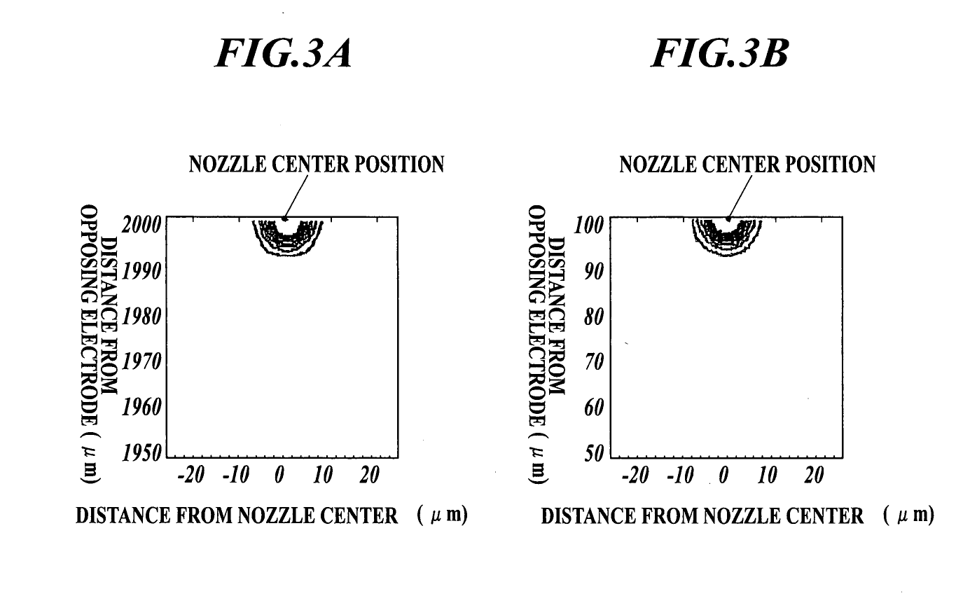

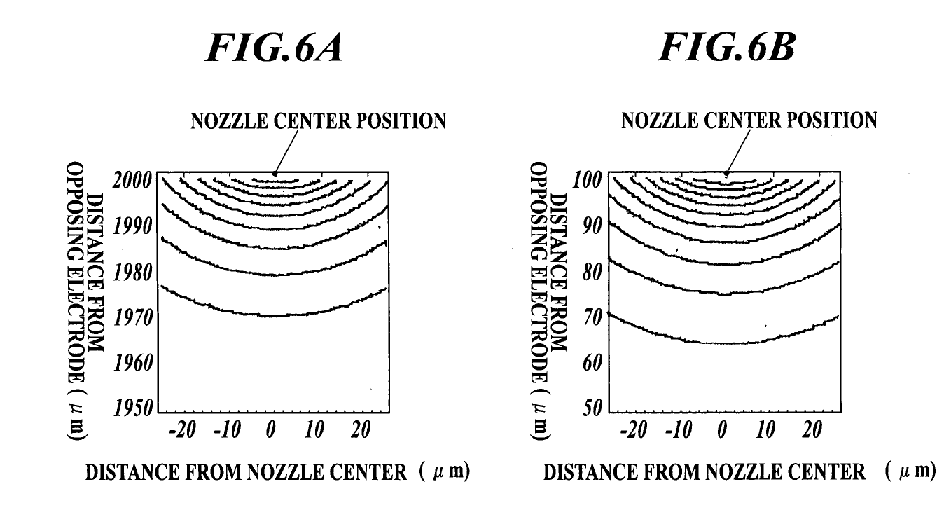

The nozzle diameter (inner diameter) of a liquid ejection apparatus in each embodiment to be explained below is preferably 25 μm or less, more preferably less that 20 μm, more preferably 10 μm or less, more preferably 8 μm or less, and much more preferably 4 μm or less. And the nozzle diameter is preferably more than 0.2 μm. The relationship between the nozzle diameter and electric field intensity will be described below with reference to FIGS. 1A to 6B. FIGS. 1A to 6B show electric field intensity distributions corresponding to the nozzle diameters φ 0.2, 0.4, 1.8, 20 μm, and 50 μm used in the conventional reference, respectively.

In each drawing, a nozzle center position indicates a center position in a liquid-ejection surface of a liquid ejection opening of the nozzle. FIGS. 1A, 2A, 3A, 4A, 5A, and 6A show the field intensity distributions when a distance between the nozzle and an opposing electrode is set to 2000 μm, and FIGS. 1B, 2B, 3B, 4B, 5B, and 6B show the distributions when the distance is set to 100 μm. Here, an applied voltage is kept constant to 200 V for every condition. Distribution lines in each drawing indicate the field intensity ranging from 1×10⁶ to 1×10⁷ V/m.

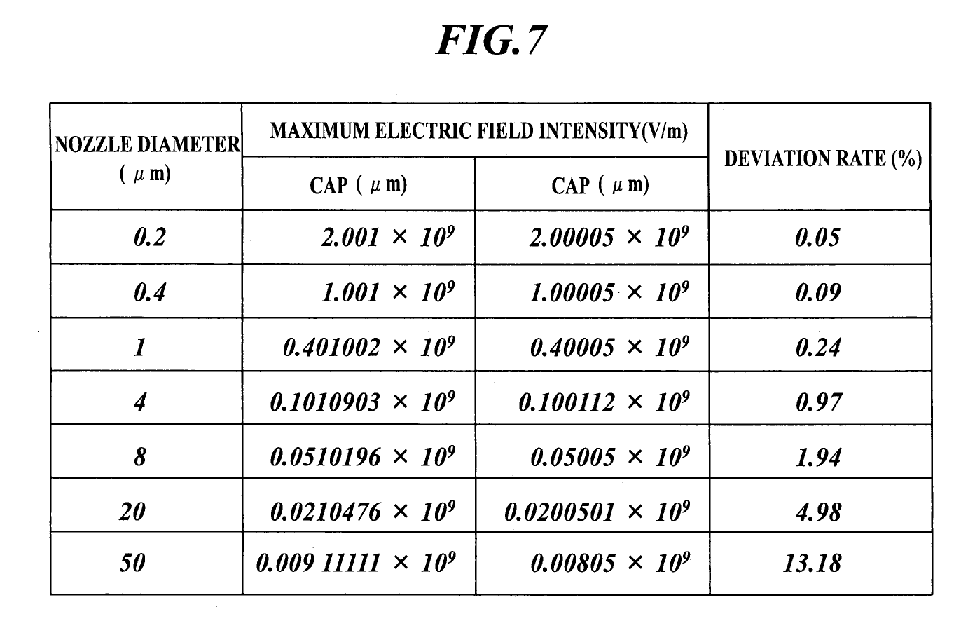

FIG. 7 is a chart showing the maximum electric field intensity under each condition.

It has been found from FIGS. 1A to 6B that the field intensity distribution expands in wide area when the nozzle diameter is set to φ 20 μm (FIGS. 5A and 5B) or larger. It has been also found from the chart FIG. 7 that the distance between the nozzle and the opposing electrode influences the electric field intensity.

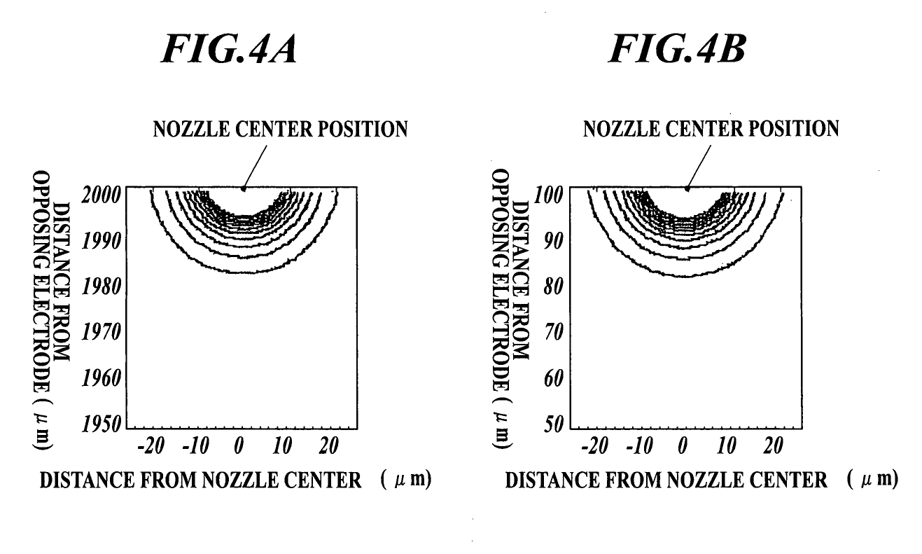

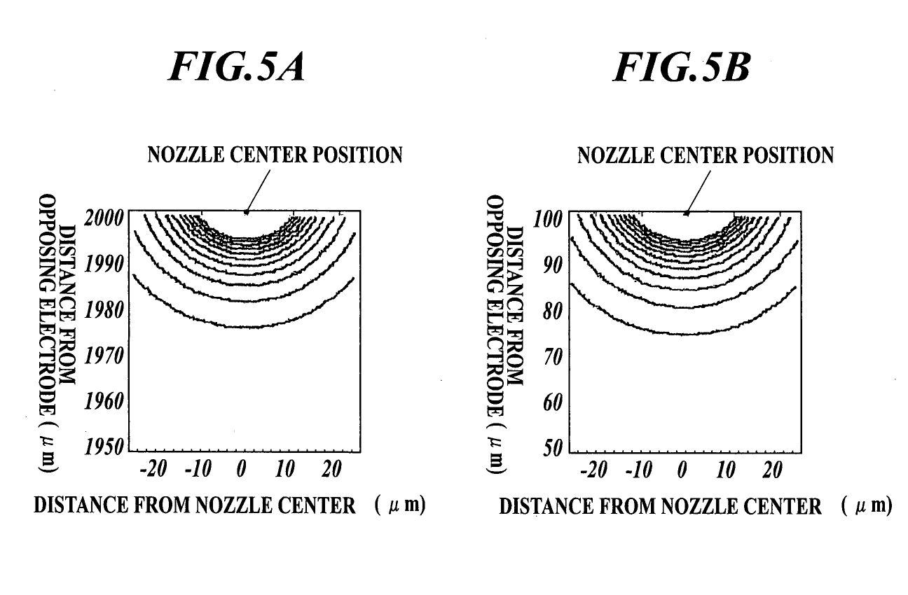

From these facts, when the nozzle diameter is φ 8 μm (FIGS. 4A and 4B) or less, electric field concentrates, and change of distance from the opposing electrode seldom affects the electric field intensity distribution. Accordingly, when the nozzle diameter is set to φ 8 μm or less, stable ejection can be attained without being affected by variation of positional accuracy of the opposing electrode and variation of material characteristics and thickness of the substrate.

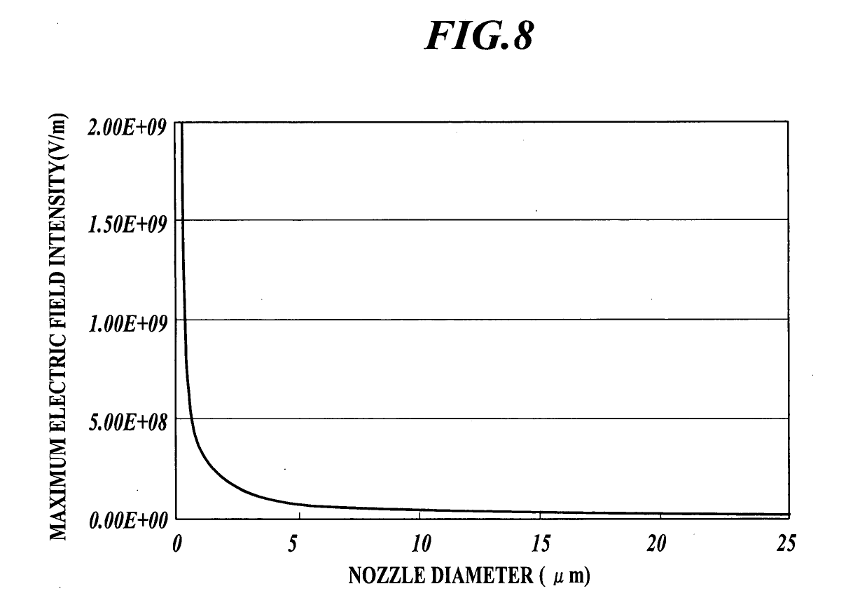

Next, FIG. 8 shows the relationship between the nozzle diameter and the maximum electric field intensity assuming that the liquid surface is at the tip position of the nozzle.

It has been found from FIG. 8 that, when the nozzle diameter is φ 4 μm or less, electric field concentration becomes extremely large and the maximum field intensity can be made higher. This allows the initial ejection speed of solution to be faster so that flying speed of a droplet can be increased and ejection response speed can be improved since charge moving speed at the nozzle tip portion increases.

Next, a description will be given on the maximum charge amount chargeable to an ejected droplet. The maximum charge amount chargeable to a droplet is shown by the following Equation (3), taking Rayleigh split (Rayleigh margin) of a droplet into account.
q=8×π×(∈₀×γ×d³₀/8)² (3)

where q is the amount of charge (C) giving Rayleigh margin, ∈₀ is the permittivity of vacuum (F/m), γ is surface tension of solution (N/m), and d₀ is a droplet diameter (m).

As the charge amount q given by Equation (3) becomes close to Rayleigh margin, electrostatic force becomes stronger even under the same electric field intensity and ejection stability is improved, however, when the amount q is too close to Rayleigh margin, solution may be scattered at the liquid ejection opening of the nozzle and results in unstable ejection, to the contrary.

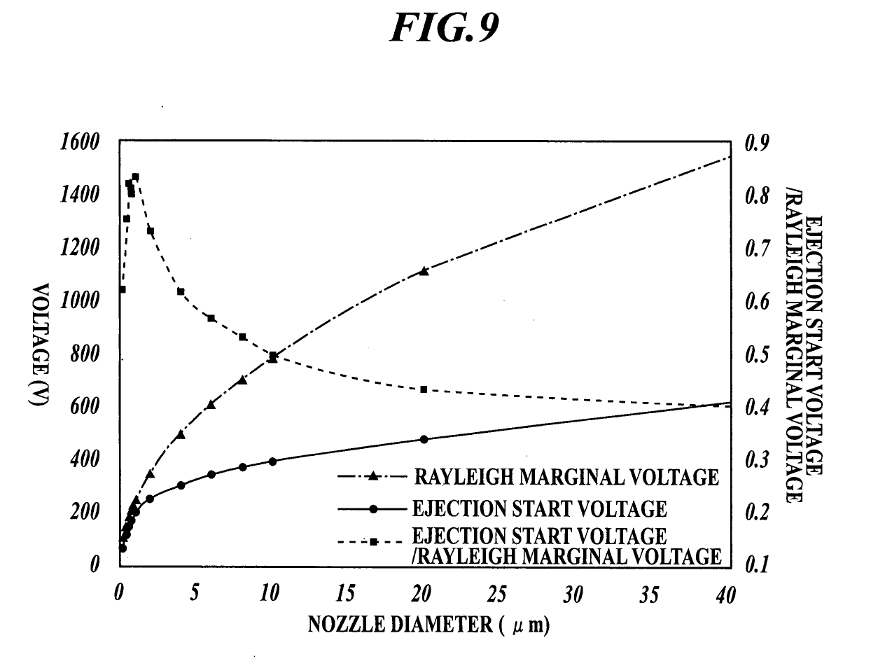

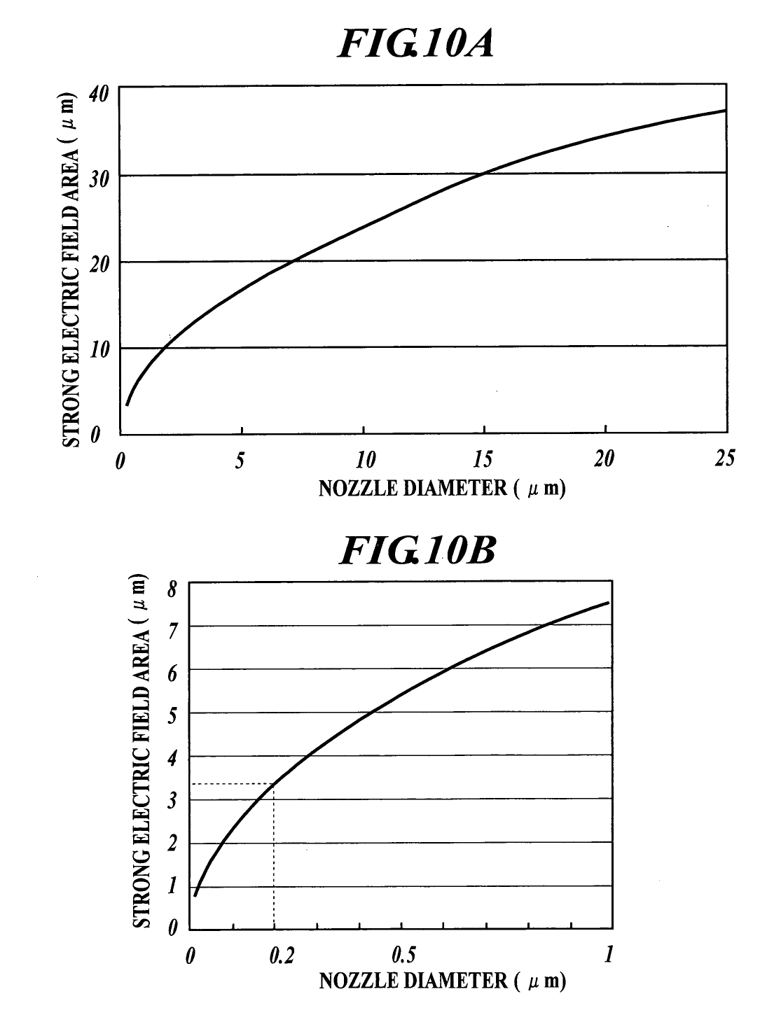

FIG. 9 shows the relationship among the nozzle diameter, ejection starting voltage at which a droplet to be ejected from the tip portion of the nozzle starts flying, Rayleigh marginal voltage of the initial ejected droplet, and a ratio of the ejection start voltage to the Rayreigh marginal voltage in the nozzle.

It has been found from the graph of FIG. 9 that, when the nozzle diameter is in the range from 0.2 to 4 μm, the ratio of the ejection starting voltage to the Rayreigh marginal voltage is over 0.6, and relatively large charge can be given to droplets even at low ejection voltage, resulting in good charging efficiency of droplets and stable ejection within the range.

For example, FIGS. 10A and 10B are graphs showing the relationship between the nozzle diameter and a strong electric field area at the tip portion of the nozzle, the area being indicated by the distance from the center of the nozzle. The graphs show that the area of electric field concentration becomes extremely narrow as the nozzle diameter becomes 0.2 μm or less. This means that an ejecting droplet cannot receive enough energy for acceleration and flying stability is reduced. Therefore, it is preferable to set the nozzle diameter to larger than 0.2 μm.

### First Embodiment

(Overall Structure of Liquid Ejection Apparatus)

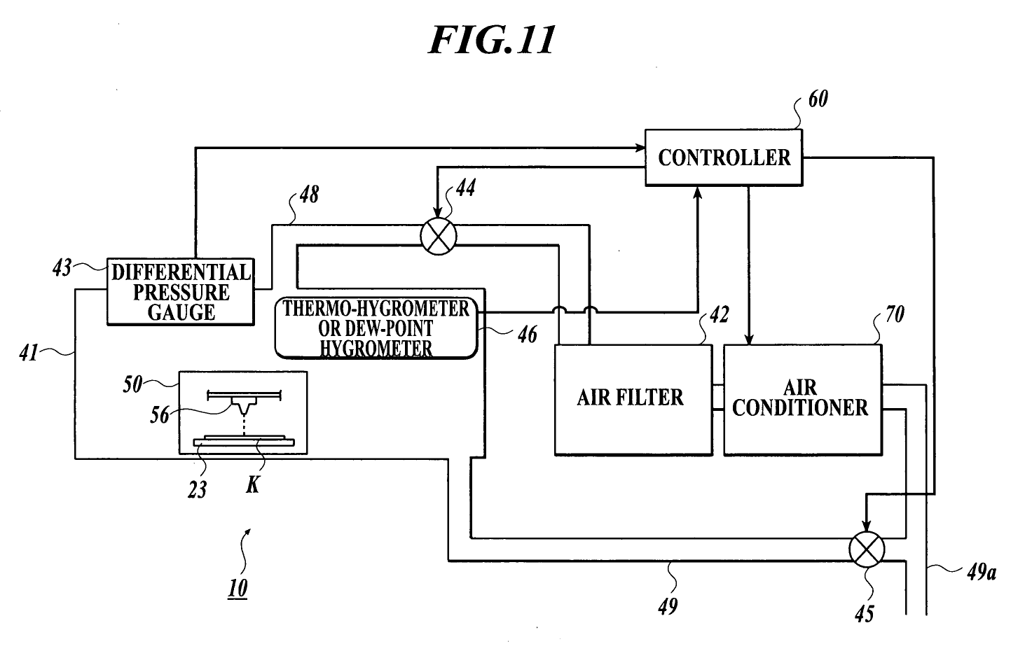

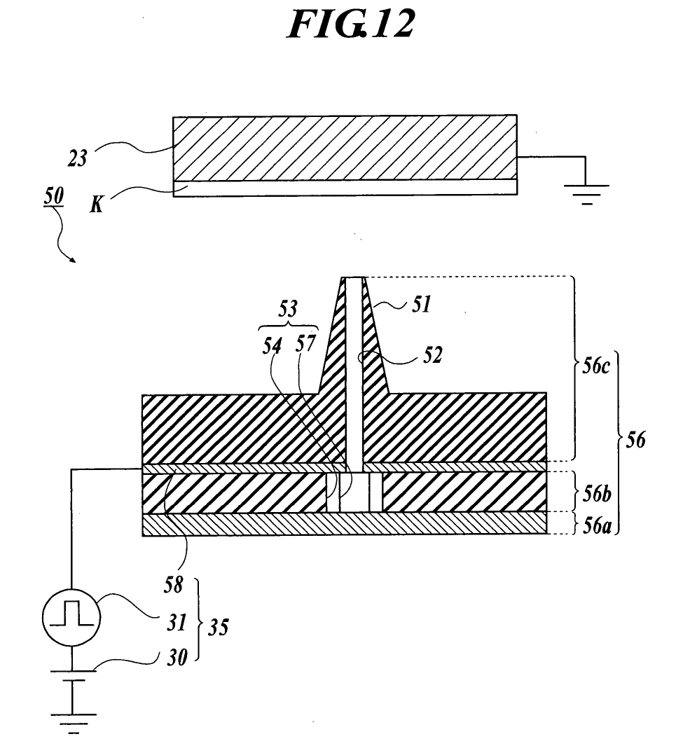

A description will now be given of a liquid ejection apparatus 10 as an embodiment of the invention with reference to FIGS. 11 to 14C. FIG. 11 is a block diagram showing a schematic structure of the liquid ejection apparatus 10.

This liquid ejection apparatus 10 includes a substrate K, a liquid ejection mechanism 50 to eject charged-solution droplets onto the substrate K, a thermostat 41 to accommodate the liquid ejection mechanism 50 and the substrate K on which the ejected droplet lands, an air conditioner 70 as a unit to adjust ejection environment to adjust the temperature and humidity of the environment inside the thermostat 41, an air filter 42 to filter dust in the air circulating between the thermostat 41 and the air conditioner 70, a differential pressure gauge 43 to detect pressure difference between the inside and the outside of the thermostat 41, a flow control valve 44 to adjust flow rate of the air circulation between the thermostat 41 and the air conditioner 70, an outlet flow control valve 45 to adjust flow rate of the exhausted amount of air circulation between the thermostat 41 and the air conditioner 70, a dew-point hygrometer 46 to detect the dew point inside the thermostat 41, and a controller 60 to perform operation control of the flow control valve 44, the outlet flow control valve 45 and the air conditioner 70.

Each part will be explained below in detail.

(Solution)

As for example of solution that performs ejection by the liquid ejection apparatus 10, concerning inorganic liquid, water, COCl₂, HBr, HNO₃, H₂SO₄, SOCl₂, SO₂Cl₂, FSO₃H, and the like can be mentioned. Concerning organic liquid, alcohols such as methanol, n-propanol, isopropanol, n-butanol, 2-methyl-1-propanol, tert-butanol, 4-methyl-2-pentanol, benzyl alcohol, alpha-terpineol, ethylene glycol, glycerin, diethylene glycol, triethylene glycol, phenols such as phenol, o-cresol, m-cresol, p-cresol, ethers such as dioxane, furfural, ethylene glycol dimethyl ether, methyl cellosolve, ethyl cellosolve, butyl cellosolve, ethyl carbitol, butyl carbitol, butyl carbitol acetate, epichlorohidrin, ketones such as acetone, methyl ethyl ketone, 2-methyl-4-pentanone, acetophenone, fatty acids such as formic acid, acetic acid, dichloro acetic acid, trichloro acetic acid, esters such as methyl formate, ethyl formate, methyl acetate, ethyl acetate, n-butyl acetate, isobutyl acetate, 3-methoxy acetate, n-pentyl acetate, ethyl propionate, ethyl lactate, methyl benzoate, diethyl malonate, dimethyl phthalate, diethyl phthalate, diethyl carbonate, ethylene carbonate, propylene carbonate, cellosolve acetate, butyl carbitol acetate, ethyl acetoacetate, methyl cyanoacetate, ethyl cyanoacetate, nitrogen containing compounds such as nitromethane, nitrobenzene, acetonitrile, propionitrile, succinonitrile, valeronitrile, benzonitrile, ethylamine, diethylamine, ethylene diamine, aniline, N-methylaniline, N,N-dimethylaniline, o-toluidine, p-toluidine, piperidine, pyridine, alpha-picoline, 2,6-lutidine, quinoline, propylenediamine, formamide, N-methylformamide, N,N-dimethylformamide, N,N-diethylformamide, acetamide, N-methylacetamide, N-methylpropionamide, N,N, N,N-tetramethylurea, N-methylpyrrolidone, sulfur containing compounds such as dimethyl sulfoxide, sulfolane, hydrocarbon such as benzene, p-cymene, naphthalene, cyclohexyl benzene, cyclohexene, halogenated hydrocarbon such as 1,1-dichloroethane, 1,2-dichloroethane, 1,1,1-trichloroethane, 1,1,1,2-tetrachloroethane, 1,1,2,2-tetrachloroethane, pentachloroethane, 1,2-dichloroethylene(cis-), tetrachloroethylene, 2-chlorobutane, 1-chloro-2-methylpropane, 2-chloro-2-methylpropane, bromomethane, tribromomethane, 1-bromopropane, and the like can be mentioned. Further, at least two of the aforementioned liquids can be mixed and used as the solution.

Additionally, in a case where ejection is performed using a conductive paste that contains a large amount of substance with high electrical conductivity (such as silver powder), an object substance which is to be dissolved or dispersed in the aforementioned solution is not limited, so far as the object substance is not a coarse particle that causes clogging in the nozzle. As for fluorescent material such as PDP, CRT, FED, and the like, conventionally known materials can be used without limitation. For example, as for red fluorescent material, (Y,Gd)BO₃:Eu, YO₃:Eu, and the like, as for green fluorescent material, Zn₂SiO₄:Mn, BaAl₁₂O₁₉:Mn, (Ba,Sr,Mg)O.α-Al₂O₃:Mn, and the like, as for blue fluorescent material, BaMgAl₁₄O₂₃:Eu, BaMgAl₁₀O₁₇:Eu, and the like can be mentioned. In order to firmly adhere the aforementioned object substances onto the record medium, it is preferable to add various kinds of binders. As for binders used, for example, cellulose and its derivatives such as ethyl cellulose, methyl cellulose, cellulose nitrate, cellulose acetate, hydroxyethyl cellulose, and the like; (meth)acryl resins such as alkyd resin, poly-(methacrylicacid), poly-(methylmethacrylate), copolymer of 2-ethylhexylmethacrylate and methacrylic acid, copolymer of laurylmethacrylate and 2-hydroxyethylmethacrylate, and the like and their metal salts; poly-(methcrylamide) resins such as poly-(N-isopropyl acrylamide), poly-(N,N-dimethyl acrylamide), and the like; stylene-based resins such as polystylene, copolymer of acrylonitrile and stylene, copolymer of stylene and maleicacid, copolymer of stylene and isoplene, and the like; stylene-acryl resins such as copolymer of stylene and n-butylmethacrylate and the like; various kinds of saturated and unsaturated polyester resins; polyolephine-based resins such as polypropylene and the like; halogenized polymers such as poly vinyl chloride, poly vinylindene chloride, and the like; vinyl resins such as poly-(vinyl acetate), copolymer of vinyl chloride and vinyl acetate, and the like; polycarbonate resins; epoxy resins; polyurethane resins; polyacetal resins such as poly vinyl formal, poly vinyl butyral, poly vinyl acetal, and the like; polyethylene based resins such as copolymer of ethylene and vinyl acetate, copolymer of ethylene and ethylacrylate, and the like; amide resins such as benzoguanamine and the like; urea resins; melamine resins; poly vinyl alcohol resins and their anion or cation alterations; poly vinyl pyrrolidone and its copolymers; homopolymers, copolymers, and crosslinked alkylene oxides such as poly ethyleneoxide, carboxylized polyethylene oxide, and the like; poly alkylglycols such as poly ethylene glycol, poly propylene glycol, and the like; poly ether polyols; SBR, NBR latex; dextrine; sodium alginate; natural or semisynthetic resins such as gelatine and its delivertives, casein, Abelmoschus manihot, tragacantha gum, pullulan, gum Arabic, locust bean gum, guar gum, pectin, carrageenan, hide glue, albumin, various kinds of starch, corn starch, alimentary yam paste, layer, agar, soy protein, and the like; terpene resin; ketone resin; rosin and rosin ester; poly-(vinyl methyl ether), poly-(ethylene imine), poly-(ethylene sulfonicacid), poly-(vinyl sulfonicacid) can be mentioned. These resins can be used not only as homopolymer, but also be blended as far as they are compatible.

In case of using the liquid ejection apparatus 10 as a patterning method, it can be typically used in display applications. Specifically, the apparatus is applicable to formation of fluorescent substance of a plasma display panel, formation of ribs of a plasma display panel, formation of electrodes of a plasma display panel, formation of fluorescent substance of a CRT, formation of fluorescent substance of an FED (field emission display) panel, formation of ribs of an FED panel, a color filter (RGB coloring layers, black-matrix layer) for liquid crystal display, a spacer for liquid crystal display (pattern corresponding to the black-matrix, dot pattern, etc.), etc. Here, the rib generally means a barrier wall and is used, for example in the plasma display panel, for separating a plasma area for each color. As for other applications, a micro-lens; pattern coating of magnetic substance, ferroelectric substance, conductive paste (wiring, antenna), and the like as semiconductor uses; normal printing; printing on a special medium (film, cloth, steel plate, and the like); printing on a curved surface; printing plates for various printing as graphic uses; coating of adhesive, sealing substance, and the like using the present invention as processing uses; coating of medical supplies (such as mixing plural small quantity of ingredients), a sample for diagnosing a gene, and the like as biological or medical uses; and the like can be mentioned.

(Substrate)

As a substrate K, any of the following substances, (1) formed of material having a surface resistance of 10⁹ Ω/cm² or less, (2) having a surface treatment layer formed on base material of insulation, the treatment layer formed of material having a surface resistance of 10⁹ Ω/cm² or less at the surface portion on which droplets are to be deposited, (3) having a surface treatment layer formed on insulation wherein treatment layer coated with a surface active agent at the surface portion on which droplets are to be deposited, can be used.

In any case, when a droplet is deposited on the surface of the substrate K, leakage of charge for the droplet is facilitated due to the low resistance of the surface portion to thereby restrain the influence on the electric field from the substrate surface.

As a method for forming the surface treatment layer on the surface of insulation in the substrate K described in above (2), the following method may be adopted.

A metal film is formed on the surface using chemical plating, vacuum evaporation, sputtering, or the like.

On the other hand, there may be also adopted such a method that solution of electro-conductive polymer, solution mixed with metal oxide or organic semiconductor, or solution solved with a surface active agent may be coated on the surface of insulation, the metal oxide being metal powder, metal fiber, carbon black, carbon fiber, tin oxide, indium oxide, etc. There may be used as a coating method spray coating, dipping, brush coating, wipe coating, roll coating, wire bar coating, extrusion coating, spin coating, etc. Any method is applicable.

As a method for forming the surface treatment layer on the surface of insulation coated with a surface active agent in the substrate K described in above (2), there may be used a low molecular surface active agent. The low-molecular surface active agent can be easily removed from the substrate by washing, wiping by cloth or the like, or decomposed and removed by heating because of low thermal-resistance. It is therefore preferable that a low molecular surface active agent is coated in advance on a substrate surface and unnecessary portions of the surface treatment layer are removed after completion of droplets ejection. This process allows the liquid ejection apparatus 20 to form a circuit with the insulation of the substrate surface maintained, which will be described later.

Since the low-molecular surface active agent is highly dependent on humidity, the thermostat 41 may be preferably adjusted by the air conditioner 70 to atmosphere of environment with necessary absolute humidity for leaving therein the substrate K coated with the surface active agent for at least one hour or more in advance before drawing a pattern.

As for surfactant of small molecular weight, concerning non-ionic agents, glycerine fatty acid ester, glycerine fatty acid ester, poly oxyethylene, poly oxyethylene, alkyl ether, alkyl poly oxyethylene, phenyl ether, N,N-bis(2-hydroxyethyl), alkyl amine (alkyl di-ethanol amine), N-2-hydroxyethyl-N-2-hydroxyalkyl amine (hydroxyalkyl monoethanolamine), poly oxyethylene alkyl amine, poly oxyethylene, alkyl amine fatty acid ester, alkyl diethanolamide, alkyl sulfonium salt, alkylbenzene sulfonium salt, alkyl phosphate, tetraalkylammonium salt, trialkylbenzyl, ammonium salt, alkyl betaine, alkyl imidazolium betaine, and the like can be mentioned.

In addition, as for surfactant of polymer, poly ether ester amide (PEEA), poly ether amide imide (PEAI), copolymer of poly ethyleneoxide-epichlorohydrin (PEO-ECH), and the like can be mentioned. Concerning anionic surfactant, alkyl phosphates (Electrostripper A of Kao Corporation, Elenon No. 19 of Dai-ichi Kogyo Seiyaku Co., LTD, for example (both of which are trademark)), concerning zwitterionic surfactant, betaines (Amogen K (trademark) of Dai-ichi Kogyo Seiyaku Co., LTD, for example), concerning nonionic surfactant, poly oxyethylene fatty acid esters (Nonion L (trademark) of NOF Corporation for example), poly oxyethylene alkyl ethers (Emulgen 106, 120, 147, 420, 220, 905, 910 of Kao Corporation, Nonion E of NOF Corporation (both of which are trademark)), can be mentioned. As for other nonionic surfactants, poly oxyethylene alkyl phenol ethers, polyalcohol fatty acid esters, poly oxyethylene sorbitan fatty acid esters, and poly oxyethylene alkyl amines are also useful.

As for material having a surface resistance of 10⁹ Ω/cm² or less, metal, electrically conductive polymer material, metal fiber, carbon black, carbon fiber, metal oxides such as tin oxide and indium oxide, organic semiconductors, and the like can be used.

As for insulative materials, shellack, Japanese lacquer, phenolic resin, urea resin, polyester, epoxy, silicone, polyethylene, polystyrol, flexible vinyl chloride resin, hard vinyl chloride resin, cellulose acetate, polyethylene terephthalate, Teflon (trademark), crude caoutchouc, flexible rubber, ebonite, butyl rubber, neoprene, silicone rubber, white mica, Japanese lacquer, micanite, micarex, asbestos board, porcelain, steatite, alumina porcelain, titanium oxide porcelain, soda glass, bolosilicate glass, silica glass, and the like can be used.

(Thermostat)

The thermostat 41 has a carry-in opening and a carry-out opening (not shown) for the substrate K, and stores inside a liquid ejection head 56 of the liquid ejection mechanism 50. The thermostat 41 is connected with an inlet pipe 48 for supplying air from the air conditioner 70 that adjusts the temperature and humidity of the air, and with an outlet pipe 49 for sending the inside air to the air conditioner 70, which makes a sealed structure shutting a flow path from the open air except the above circulation. The thermostat also has a heat insulating structure with less influence from outside temperature.

At an upstream side of the air conditioner 70 in the outlet pipe 49, there is provided an open-air inlet 49a, and the open air brought into from this inlet is applied the air conditioning by the air conditioner 70 to be supplied to the thermostat 41. A blower may be provided in the middle of the outlet pipe 49 to positively exhaust or take in the open air. Additionally, a flow-meter may be provided in the inlet pipe 48 or in the outlet pipe 49 to detect the flow rate and output the result to the controller 60.

The air from the open air is flown in the embodiment, but inert gas or other gas may be used instead without taking in the open air. When the inert gas is used, unit for supplying the gas may be provided to circulate the inert gas. Here, there may be employed as the inert gas nitrogen, argon, helium, neon, xenon, krypton, etc.

The air filter 42 is provided in the middle of the inlet pipe 48, but may be additionally provided at the open-air inlet 49a.

(Differential Pressure Gauge, Flow Control Valve and Outlet Flow Control Valve)

The differential pressure gauge 43 detects a pressure difference between the inside and outside of the thermostat 41 and outputs the result to the controller 60. The flow control valve 44 and the outlet flow control valve 45 are solenoid valves, and each valve travel is controlled by a control signal from the controller 60. The controller 60 controls to adjust passing flow rate of the air by the flow control valve 44 and the outlet flow control valve 45 so that the inside pressure of the thermostat 41 is equal to or a little bit higher than the outside pressure based on the pressure difference detected by the differential pressure gauge 43. The inside pressure is preferably set to a little bit higher than the outside one to prevent the outside air, which has a different temperature or humidity from a target value, from flowing into the thermostat 41.

(Dew-Point Hygrometer)

The dew-point hygrometer 46 detects the dew point of the atmosphere inside the thermostat 41, and sends the result to the controller 60. A dew point can be calculated from the inside temperature and humidity of the thermostat, therefore a thermo-hygrometer may be installed instead of the dew-point hygrometer 46, and the dew point can be calculated from the output.

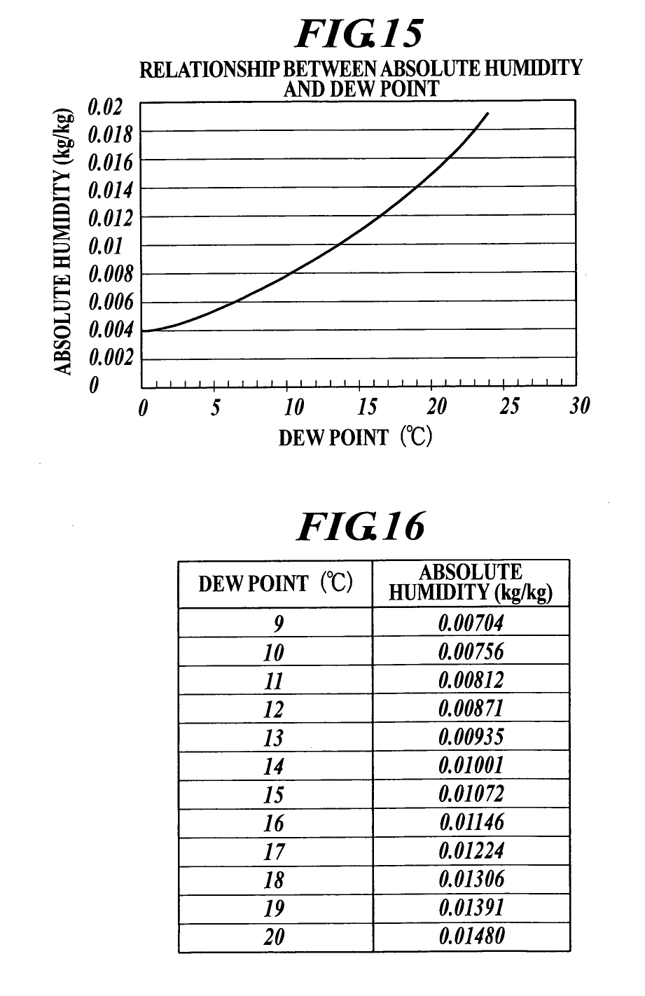

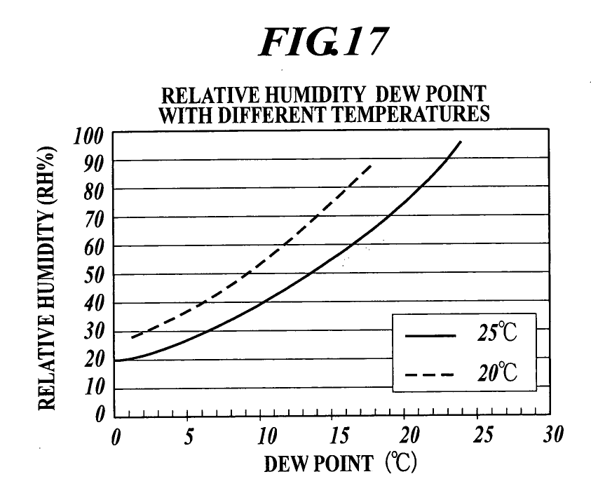

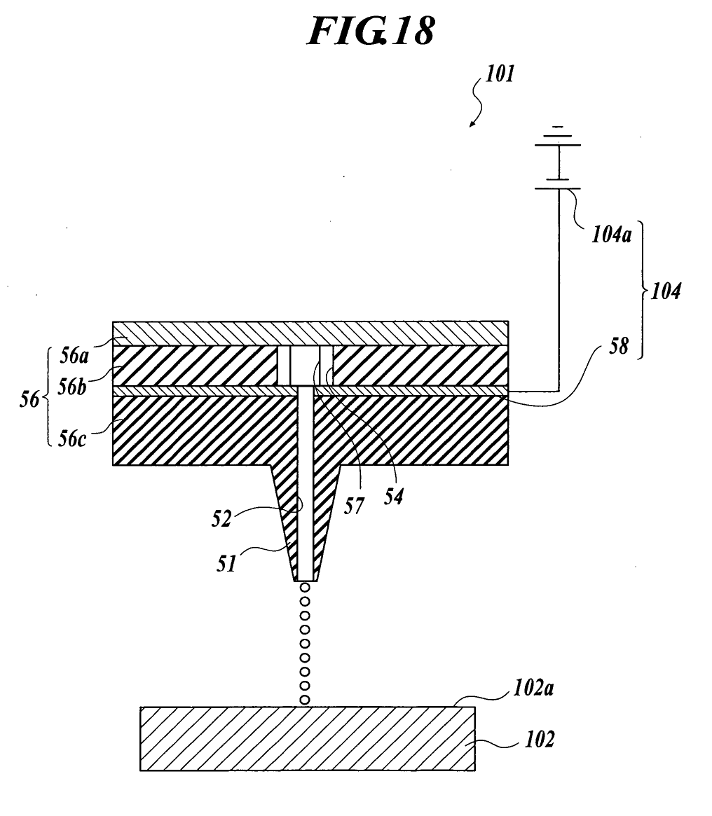

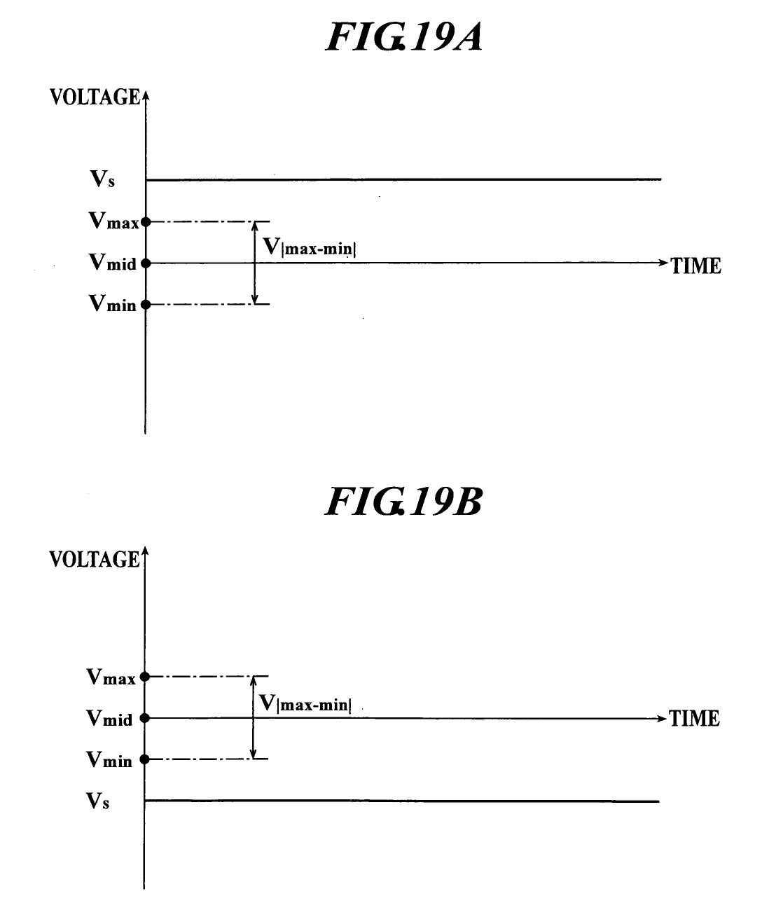

Since a dew point has a relationship with an absolute humidity (mixing ratio) as shown in FIGS. 15 and 16, the dew point may be figured out after obtaining an absolute humidity.

Similarly, according to the relationship between a dew point and a relative humidity as shown in FIG. 17, the dew point may be figured out after obtaining a relative humidity. The relative humidity is presented by percentage of vapor in gas to saturated quantity of vapor in the gas.

(Air Conditioner)

The air conditioner 70 includes a blower to circulate air to the thermostat 41, a heat exchanger to heat or cool the passing air, and a humidifier and a dehumidifier provided at its downstream side. According to control of the controller 60, the air conditioner 70 heats or cools, or humidifies or dehumidifies the air passing through the conditioner 70.

(Controller)

The controller 60 controls dew point of the atmosphere inside the thermostat 41 in addition to the aforementioned control of inside pressure of the thermostat 41. That is, the controller 60 calculates a dew point and saturation temperature from the output of the dew-point hygrometer 46, and performs temperature control, humidity control or their combination control using a control method such as PID (proportion-integration-differential) control so that the dew point becomes 9 degrees centigrade or more.

(Liquid Ejection Mechanism)

The liquid ejection mechanism 50 is arranged inside the aforementioned thermostat 41, and a liquid ejection head 56 is transported in a given direction by a head drive unit (not shown).

FIG. 12 is a cross-sectional view of the liquid ejection mechanism 50 taken along a nozzle.

The liquid ejection mechanism 50 includes the liquid ejection head 56 having a super-minute diameter of nozzle 51 for ejecting droplets of chargeable solution from the tip portion, an opposing electrode 23 having a surface opposing the tip portion of the nozzle 51 and supporting a substrate K for receiving droplets at the opposing surface, a solution supply unit 53 for supplying solution to a flow passage 52 inside the nozzle 51, and an ejection voltage applying unit 35 for applying an ejection voltage to the solution inside the nozzle 51. Here, the nozzle 51, a part of the solution supply unit 53 and a part of the ejection voltage applying unit 35 are integrally formed into the liquid ejection head 56.

The tip portion of the nozzle 51 is shown directing upward in FIG. 12 as a matter of convenience for explanation, but the nozzle 51 is actually used directing toward horizontal direction or a lower direction, and more preferably vertically downward.

(Nozzle)

The nozzle 51 is integrally formed with a plate portion of a nozzle plate 56c, and mounted perpendicular to a flat surface of the nozzle plate 56c. When droplets are ejected, the nozzle 51 is used directing perpendicular to the receiving surface (the surface where droplets land) of the substrate K. The nozzle 51 has an inside-nozzle flow passage 52 passing through along the center of the nozzle 51 from the tip portion.

The nozzle 51 will be explained in more detail. The opening diameter at the tip portion is uniform with that of the inside-nozzle flow passage 52 in the nozzle 51, and these are formed by an extremely small diameter as described above. Specifically, for example, the inside diameter of the inside-nozzle flow passage 52 is set to 25 μm or less, preferably less than 20 μm, more preferably 10 μm or less, more preferably 8 μm or less, much more preferably lass than 4 μm or less, and to 1 μm in the embodiment. An outside diameter at the tip portion of the nozzle 51 is set to 2 μm, a diameter at the root of the nozzle 51 to 5 μm, and a height of the nozzle 51 to 100 μm. The nozzle is formed in an almost conically truncated shape. The inside diameter of the nozzle is preferably set to more than 0.2 μm. Meanwhile, the height of the nozzle 51 may be 0 μm. That is, the nozzle 51 may be formed at the same height as of the nozzle plate 56c, and the ejection opening may be simply formed at the lower surface of the flat nozzle plate 56c, passing through the inside-nozzle flow passage 52 to a solution chamber 54.

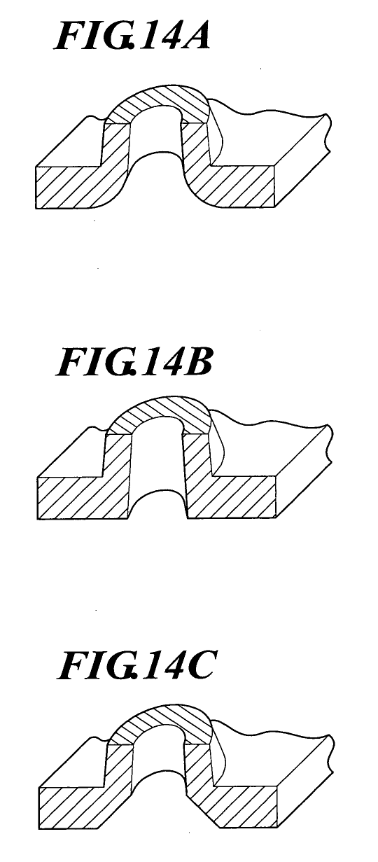

The shape of the inside-nozzle flow passage 52 may not be formed straight with uniform inside diameter as shown in FIGS. 14A, 14B and 14C. For example, as shown in FIG. 14A, the flow passage 52 may be formed rounded in a cross-sectional shape at the end of the solution-chamber 54 side, which will be explained later. As shown in FIG. 14B, an inside diameter at the end of the solution-chamber 54 side of the flow passage 52 may be set larger than that at the orifice side so that the inside surface of the flow passage 52 may be formed in a tapered circumferential shape. Further, as shown in FIG. 14C, the flow passage 52 may be formed in a shape of tapered circumferential surface only at the end of the solution-chamber 54 side and formed in straight with uniform inside diameter at the orifice side from the tapered surface.

The liquid ejection head 56 is provided with only one nozzle 51 in FIG. 12, but may be provided with a plurality of nozzles 51. When provided with a plurality of nozzles 51, each nozzle 51 may preferably have an ejection electrode 58, a supply channel 57 and a solution chamber 54 independently.

(Solution Supply Unit)

The solution supply unit 53 includes a solution chamber 54 provided inside the ejection head 56 at the root of the nozzle 51 and communicating with the flow passage 52, a supply channel 57 for supplying solution to the solution chamber 54, and a supply pump (not shown) including a piezoelectric element or the like for applying a supply pressure of solution to the solution chamber 54.

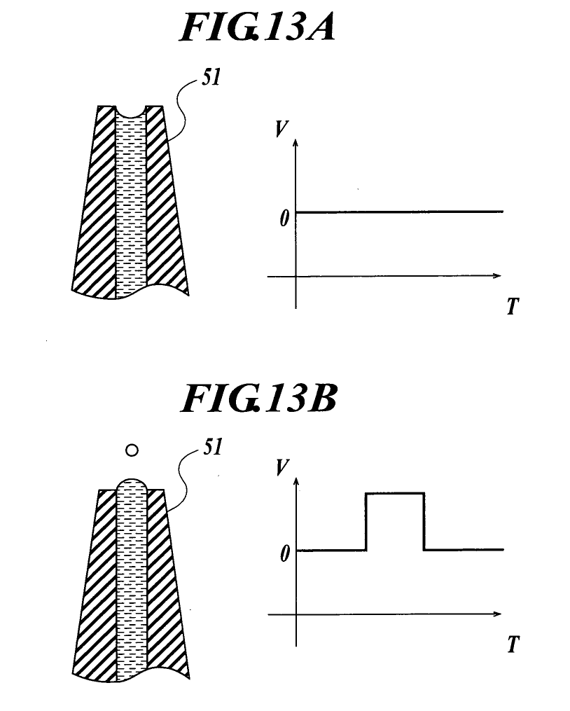

The supply pump supplies solution to the tip portion of the nozzle 51 with the supply pressure maintained so that the solution does not spill out of the tip portion (see FIG. 13A).

The supply pump includes such a case that utilizes a pressure difference due to arranged positions between the liquid ejection head and a supply tank and may be constructed only by a solution-supply passage without providing a separate solution supply unit. The pump basically starts operation when solution is supplied to the liquid ejection head at the time of starting, though depending on design, to eject liquid from the ejection head 56. The solution is supplied according to the ejection of liquid with optimization of the volume change inside the ejection head 56 and the pressure of the supply pump.

(Ejection Voltage Applying Unit)

An ejection voltage applying unit 35 includes an ejection electrode 58 provided at a boundary position between the solution chamber 54 and the flow passage 52 inside the liquid ejection head 56 for applying ejection voltage, a bias voltage supply 30 for constantly applying DC bias voltage to the ejection electrode 58, and an ejection voltage supply 31 for applying to the ejection electrode 28 a pulse voltage necessary for ejection with superposition on the bias voltage.

The ejection electrode 58 directly contacts the solution at the inside of the solution chamber 54 to charge the solution and to apply the ejection voltage.

The bias voltage by the bias supply 30 is always applied to the solution to an extent not to eject solution to thereby previously reduce the voltage to be applied at the time of ejection and improve responsibility of ejection.

The ejection voltage supply 31 applies a pulse voltage with superposition on the bias voltage only at the time of ejecting solution. The pulse voltage is so set that the superposed voltage V satisfies a condition presented by the following expression (1).

$$h \sqrt{\frac{γ π}{{ɛ}_{0} d}} > V > \sqrt{\frac{λ k d}{2 {ɛ}_{0}}} \qquad ( 1 )$$

where γ: surface tension of solution (N/m), ∈₀: permittivity of vacuum electric constant (F/m), d: nozzle diameter (m), h: distance between nozzle and substrate (m), k: proportional constant depending on nozzle shape (1.5<k<8.5).

As one example, when the bias voltage is DC 300 V and the pulse voltage is 100 V, then the superposed voltage at the time of ejection is 400 V.

(Liquid Ejection Head)

The liquid ejection head 56 includes a base layer 56a positioned at the lowest layer in FIG. 12, a flow channel layer 56b positioned over the base layer for forming a supply channel of solution, and a nozzle plate 56c formed over the flow channel layer 56b, and the ejection electrode 58 is interposed between the flow channel layer 56b and the nozzle plate 56c.

The base layer 56a is formed of silicone substrate or high insulation of resin or ceramic. There is formed over the base layer a soluble resin layer, removed other portions than given patterns for forming the supply channel 57 and the solution chamber 54, and formed an insulative resin layer on the removed portions. This insulative resin layer becomes the flow channel layer 56b. There is formed over the insulative resin layer the ejection electrode 58 by plating conductive material (for example, NiP), and formed further over the electrode an insulative photo-resist resin layer. This photo-resist resin layer will become the nozzle plate 56c, so that this resin layer is formed with thickness taken into account the height of the nozzle 51. This insulative photo-resist resin layer is lithographed by an electron beam method or femto-second laser to form the nozzle shape. The inside-nozzle flow passage 52 is also formed by lithography and development. Then, a soluble resin layer along the supply channel 57 and the solution chamber 54 is removed to form the supply channel 57 and the solution chamber 54, thus completing the liquid ejection head 56.

Here, material of the nozzle plate 56c and the nozzle 51 may be, specifically, insulation such as epoxy, PMMA, phenol, soda glass, quarts glass, etc.; semiconductor such as Si; or conductor such as Ni, SUS, etc. However, when the nozzle plate 56c and the nozzle 51 are formed of conductor, at least a top edge of the tip portion of the nozzle 51, preferably a circumferential surface of the tip portion is to be covered with a film of insulation. When the nozzle 51 is formed of insulation or of insulative film covering the surface of the tip portion, it is possible to effectively suppress current leakage from the nozzle tip portion to the opposing electrode 23 when the ejection voltage is applied to the solution.

The nozzle plate 108 including the nozzle 51 may have water repellency (for example, the nozzle plate 108 is formed of resin containing fluorine), or may be formed of a water-repellent film having water repellency at a surface layer of the nozzle 51 (for example, the surface layer of the nozzle plate 108 is formed of a metal film, and formed over the metal film is a water repellent layer by eutectoid plating with metal and water repellent resin). Here, the water repellency is a characteristic of repelling liquid. By selecting a water-repellent processing method according to liquid, water repellency of the nozzle plate 108 can be controlled. As water-repellent processing methods, electrodeposition of cationic or anionic fluorine-containing resin, topical application of fluoropolymer, silicone resin, poly dimethylsiloxane, sintering method, eutectoid deposition of fluoropolymer, vapor deposition of amorphous alloy plating film, adhesion of organic silicone compounds, fluorine-containing organic silicone compounds, and the like, that are mainly made of poly dimethylsiloxane, which is obtained through plasma polymerization of plasma CVD method, where the monomer used is hexamethyl disiloxane, can be mentioned.

(Opposing Electrode)

The opposing electrode 23 has an opposing surface perpendicular to a projecting direction of the nozzle 51, and supports the substrate K along the opposing surface. A distance between the tip portion of the nozzle 51 and the opposing electrode 23 is preferably set to 500 μm or less, more preferably to 400 μm or less, and to 100 μm as one example.

The opposing electrode 23 is grounded, and therefore maintains ground potential. Accordingly, when the pulse voltage is applied, an ejected droplet is induced to a side of the opposing electrode 23 by electrostatic force due to an electric field produced between the tip portion of the nozzle 51 and the opposing surface.

In the liquid ejection mechanism 50, the electric field is enhanced by electric field concentration at the tip portion of the nozzle 51 because of the extremely small nozzle 51, therefore a droplet can be ejected without induction by the opposing electrode 23, but it is preferable to perform induction by electrostatic force between the nozzle 51 and the opposing electrode 23. Further, this structure allows the charge of the charged droplet to be released by grounding the opposing electrode 23.

(Ejecting Operation of Micro-Droplet by Liquid Ejection Mechanism)

Ejecting operation in the liquid ejection mechanism 50 will be explained with reference to FIGS. 12 to 13B.

Solution is supplied to the inside-nozzle flow passage 52, and the bias voltage supply 30 applies the bias voltage to the solution through the ejection electrode 58 in this state. This allows the solution to be charged and to form a concave meniscus at the tip portion of the nozzle 51 (FIG. 13A).

Then, when the ejection voltage supply 31 applies the ejection pulse voltage, the solution is guided to the tip portion of the nozzle 51 by the electrostatic force due to the electric field concentrated to the tip portion of the nozzle 51, which forms a convex meniscus protruding outward. The electric field concentrates to the vertex of the convex meniscus to finally eject a micro-droplet to the opposing electrode side against surface tension of the solution (FIG. 13B).

(Overall Operation of Liquid Ejection Apparatus)

The substrate K is carried onto the opposing electrode 23 of the liquid ejection mechanism 50 inside the thermostat 41. At this time, the controller 60, according to the detected result of the differential pressure gauge 43, controls the flow control valve 44 and the outlet flow control valve 45 to adjust the pressure inside the thermostat 41 to a little bit higher than that of the outside. The air conditioner 70 operates to circulate the air inside the thermostat 41, and the controller 60 adjusts the dew point to be 9 degrees centigrade or more by heating and humidifying with the air conditioner 70 when a dew point given by the dew-point hygrometer 46 is less than 9 degrees centigrade.

In this atmosphere, there is performed ejection operation of droplets by the aforementioned liquid ejection mechanism 50.

(Effects of the Embodiment)

The liquid ejection mechanism 50 ejects a droplet using the micro-diameter of nozzle 51 that has never been achieved, so that an electric field is concentrated by the solution charged in the inside-nozzle flow passage 52 to heighten the electric field intensity. In a conventional nozzle (for example, inside diameter is 100 μm), the voltage necessary for ejection has become too high because an electric field is not concentrated, but using a minute diameter of nozzle, which was thought be actually impossible, allows ejection of solution at lower voltage than before.

Because of the micro-diameter of nozzle, control of reducing ejection flow rate per unit time can be easily achieved due to low nozzle conductance, and realized also is ejection of droplets with a sufficiently small diameter (0.8 μm under the above conditions).

Further, since the ejected droplet is charged, vapor pressure is reduced even for a minute droplet so that a loss of droplet-mass is reduced by suppression of evaporation, which stabilizes flying and prevents landing precision of droplets from being lowered.

Further, in the liquid ejection apparatus 10, since the controller 60 adjusts the dew point of atmosphere inside the thermostat 41 to 9 degrees centigrade or more, leakage of charge of deposited droplets from the substrate surface is accelerated, so that there is suppressed influence from the electric field due to the charge of droplets deposited on the surface of the substrate K. This allows improvement of positional precision for a droplet to land, and also size variation of ejected droplets and deposited dots to be suppressed and stabilized.

Further, according to material of the substrate K itself, material of the surface treatment layer, or coating of a surface active agent, the surface resistance is set to 10⁹ Ω/cm² at least at the area for droplets to land on the surface of the substrate K. Therefore, leakage of charge of deposited droplets from the substrate surface is more accelerated, and there is more suppressed influence from the electric field due to the charge of droplets deposited on the surface of the substrate K. This allows further improvement of positional precision for a droplet to land, and also size variation of ejected droplets and deposited dots to be suppressed and stabilized much more.

(Others)

In order to get electro-wetting effect, there may be provided an electrode on an outer surface of the nozzle 51, or provided an electrode on the inside surface of the inside-nozzle flow passage 52, the inside electrode being covered thereon with an insulative film. When a voltage is applied to this electrode, the electro-wetting effect can improve wettability of the inside surface of the flow passage 52 for the solution to which the voltage is applied by the ejection electrode 58, allowing smooth supply of solution to the flow passage 52 and improvement of ejection response.

In the ejection voltage applying unit 35, pulse voltage is applied for triggering ejection of a droplet with constant application of bias voltage, but such a structure may be employed that an AC or continuous rectangular waveform is constantly applied with the amplitude necessary for ejection and ejection is performed by switching the frequency high and low. Since charging solution is necessary for ejecting a droplet, when ejection voltage is applied with higher frequency beyond the speed of charging the solution, the solution is not ejected, and switching the frequency to that for the solution to be sufficiently chargeable causes the solution to be ejected. Therefore, ejection of solution can be controlled such that, when ejection is suspended, ejection voltage is applied with a higher frequency than that capable of ejecting, and the frequency is lowered to a frequency band capable of ejecting only at the time of ejection. In this case, potential itself applied to the solution is not changed, so that time responsibility is more improved and resultantly landing precision of droplets can be improved.

In the liquid ejection head 56 described above, material itself of the nozzle 51 is insulation, and dielectric breakdown voltage of the formed nozzle may be 10 kV/mm or more, preferably 21 kV/mm or more, and more preferably 30 kV/mm or more. Such cases can also achieve almost the same effect as in the nozzle 51.

(Application to Formation of Wiring Pattern of Circuit Board)

The liquid ejection apparatus 10 described above may be applied to formation of a wiring pattern of a circuit board.

In this case, solution to be ejected by a solution ejection apparatus 20 contains in the solution a plurality of minute particles or adhesive particles having adhesion for bonding to each other to form an electronic circuit, and a dispersing agent for dispersing the minute particles or adhesive particles.

As for minute particles, particles of metal and metal compounds can be used. As for the fine particles, electrically conductive fine particles such as Au, Pt, Ag, In, Cu, Ni, Cr, Rh, Pd, Zn, Co, Mo, Ru, W, Os, Ir, Fe, Mn, Ge, Sn, Ga, In, and the like can be mentioned. Especially when metal fine particles of Au, Ag, or Cu is used, it is preferable since electrical circuit with low electrical resistance and high corrosion resistance can be achieved. As for fine particles of metal compounds, electrically conductive fine particles such as ZnS, CdS, Cd₂SnO₄, ITO(In₂O₃—SnO₂), RuO₂, IrO₂, OSO₂, MoO₂, ReO₂, WO₂, YBa₂Cu₃O₇-x, and the like, fine particles that show electrical conductivity through reduction by heat such as ZnO, CdO, SnO₂, InO₂, SnO₄, and the like, semiconductive fine particles such as Ni—Cr, Cr—SiO, Cr—MgF, Au—SiO₂, AuMgF, PtTa₂O₅, AuTa₂O₅Ta₂, Cr₃Si, TaSi₂, and the like, conductive fine particles such as SrTiO₃, BaTiO₃, Pb(Zr,Ti)O₃, and the like, and semiconductive fine particles such as SiO₂, Al₂O₃, TiO₂, and the like can be mentioned.

As for adhesive particles, adhesives of thermosetting resin type, adhesives of rubber type, adhesives of emulsion type, poly aromatics, adhesives of ceramics type, and the like can be mentioned.

Dispersing agent acts as a protective colloid for fine particles. As for such dispersing agent, block copolymer of polyurethane and alkanolamine, polyester, poly acrylonitrile, and the like can be used.

Solvent is chosen in terms of affinity with fine particles. Specifically, as for solvent, solvents with water as main constituent, PGMEA, cyclohexane, (butyl)-carbitolacetate, 3-dimethyl-2-imidazoline, BMA, solvents with propylene monomethyl acetate as main constituent, and the like can be mentioned.

A description will be given of a method for preparing aqueous solution dissolving, for example, metal minute particles as the minute particles. First, into a solution of metal ion source such as chloroauric acid and silver nitrate, water soluble polymer is dissolved, and within agitation, alkanol amine such as dimethyl amino ethanol is added. In several tens of seconds to several minutes, the metal ion is reduced, and metal fine particles with average particle diameter equal to or less than 100 nm precipitates. Subsequently, chlorine ion and nitrate ion is removed from the solution containing the precipitant by methods such as ultrafiltration technique, and the resulting solution is condensed and dried. The water borne solution prepared by the aforementioned method can be stably dissolved and blended with binders for sol-gel process, such as water, alcohol based solvents, tetraethoxy silane, triethoxy silane, and the like.

Next, a method to prepare a oil borne solution with metal fine particle as a fine particle dissolved, is described.

First, oil soluble polymer is dissolved in a water-miscible organic solvent such as acetone, and this solution is blended with the water borne solution prepared by the aforementioned method. The mixture is a heterogeneous system at first, however, by adding alkanol amine within agitation to this mixture, the metal fine particle precipitate in the oil phase, within the form dispersed in the polymerized material. By washing, condensing, and drying the solution, the oil borne solution is obtained. The oil borne solution prepared by the aforementioned method can be stably dissolved and blended with solvents such as aromatic solvents, ketones, esters, and the like; polyester; epoxy resin; acryl resin; polyurethane resin; and the like.

When forming a wiring pattern, first, a surface active agent is coated on the surface of a glass-made board as a substrate, the surface for the wiring pattern to be formed thereon (forming process of a surface treatment layer). For such a surface active agent, a low-molecular agent described before is preferably used taking into account later removal. Specifically, an antistatic agent, Colcoat 200™ (of Colcoat Inc,) is coated in the embodiment, whereby surface resistance of the formed surface treatment layer becomes 10⁹ Ω/cm².

Next, the board is disposed inside the thermostat 41, and droplets are ejected by the liquid ejection mechanism 50 to form the wiring pattern (droplet ejection process). At this time, Silver Nano Paste™ (of Harima Chemicals, Inc.) is specifically used as the droplets to form the wiring pattern having a line width of 10 μm and a length of 10 mm.

After ejection of droplets, a solvent of the solution is evaporated, thereafter or simultaneously the board is heated at 200 degrees centigrade for 60 minutes (pattern fixing process).

Thereafter, the glass board on which formation of the wiring pattern has completed is washed by pure water for 10 minutes (surface treatment layer removing process). With this process, the surface treatment layer of Colcote 200 except the deposited positions is washed away and removed. Surface resistance of the portion of the glass-board surface, where the surface treatment layer is removed, becomes 10¹⁴ Ω/cm².

That is, the portion except the wiring pattern has high insulation capability, which allows formation of fine and high-density wiring patterns without occurrence of short circuit or the like.

### Second Embodiment

A description will be given of a liquid ejection mechanism 101 according to a second embodiment of an electrostatic attraction type liquid ejection apparatus with reference to FIG. 18. FIG. 18 is a view showing main parts of the liquid ejection mechanism 101. The nozzle 51 is presented directing downward in the same manner as in actual use. Here, those elements which are the same elements as in the aforementioned liquid ejection mechanism 50 are designated by the same reference numerals and repeated description thereof will be omitted.

It is assumed that the liquid ejection mechanism 101 is not used inside the thermostat 41 that can be set to a suitable dew point, which differs from the aforementioned liquid ejection mechanism 50. Therefore, the liquid ejection mechanism 101 uses a different method from that used in the liquid ejection mechanism 50 to suppress influence from uneven potential distribution on a substrate surface. A description will be focused on this difference.

As shown in FIG. 18, the liquid ejection mechanism 101 includes a liquid ejection head 56 for ejecting chargeable liquid toward an insulative substrate 102, and an ejection voltage applying unit with charging unit 104 that drives the ejection head 56 by a voltage signal for ejecting operation and also drives the ejection head 56 for charging the insulative substrate 102.

(Insulative Substrate)

The insulative substrate 102 is formed of insulation (dielectrics) having very high resistivity, and surface resistivity (sheet resistance) of a surface 102a is preferably 10¹⁰ Ω/cm² or more, and more preferably 10¹² Ω/cm² or more. For example, the insulative substrate is formed of, shellack, Japanese lacquer, phenolic resin, urea resin, polyester, epoxy, silicone, polyethylene, polystyrol, flexible vinyl chloride resin, hard vinyl chloride resin, cellulose acetate, polyethylene terephthalate, Teflon (trademark), crude caoutchouc, flexible rubber, ebonite, butyl rubber, neoprene, silicone rubber, white mica, micanite, micarex, asbestos board, porcelain, steatite, alumina porcelain, titanium oxide porcelain, soda glass, bolosilicate glass, silica glass, and the like. Here, the insulative substrate 102 may have a shape of plate, disk, sheet or pedestal.

Here, the insulative substrate 102 may have a shape of plate, disk, sheet or pedestal.

The insulative substrate 102 is separated apart from conductive material, such as grounding, wiring or electrode, and is in an electrically floating state. Accordingly, the surface 102a may be charged (without limitation of positive or negative charge) or discharged.

In case that the liquid ejection mechanism 101 is applied to an inkjet printer, a recording medium, such as paper, a plastic film or sheet member, corresponds to the insulative substrate 102. When the substrate 102 has a sheet-like shape, a support member such as a platen may be arranged opposing to the liquid ejection head 56, the support member supporting the substrate 102 in contact with its backside surface and also being made of insulation. Forming the support member with insulation makes the substrate 102 electrically floated.

Other surface except the surface 102a of the substrate 102 may contact to conductive member such as grounding, wiring, electrodes, taking into account the resistivity. Wiring or electrodes may be formed on a part, not all, of the surface 102a. That is, wiring, electrodes or other conductive member may be formed on the surface 102 except the portions on which liquid is deposited. The aforementioned opposing electrode 23 may be provided at the back of the substrate 102 (a reverse side of the substrate 102 relative to the ejection head 56).

The liquid ejection mechanism 101 may be preferably provided with a substrate moving mechanism for moving the substrate 102 along a surface crossing the direction toward which liquid is ejected from the ejection head 56. Particularly, the substrate moving mechanism may move the substrate 102 along a surface perpendicular to the liquid-ejection direction (hereinafter, “perpendicular surface”), and further may move the substrate 102 along the perpendicular surface by moving the substrate 102 in two directions perpendicular to each other in the perpendicular surface. The substrate moving mechanism may move the substrate 102 only in one direction in the perpendicular surface, and such a substrate moving mechanism is used in an inkjet printer as a transport mechanism for transporting a recording medium.

The liquid ejection mechanism 101 may be preferably provided with a head moving mechanism for moving the liquid ejection head 56 along a surface crossing the direction toward which liquid is ejected from the ejection head 56. Particularly, the head moving mechanism may move the ejection head 56 along a surface perpendicular to the liquid-ejection direction (hereinafter, “perpendicular surface”), and further may move the ejection head 56 along the perpendicular surface by moving the ejection head 56 in two directions perpendicular to each other in the perpendicular surface. When the substrate moving mechanism moves the substrate 102 only in one direction in the perpendicular surface, the head moving mechanism reciprocates the ejection head 56 in a direction perpendicular to the moving direction of the substrate 102.

(Ejection Voltage Applying Unit with Charging Unit)

The ejection voltage applying unit with charging unit 104 includes a steady voltage applying part 104a for applying to the ejection electrode 58 a steady voltage with reference to the ground. Here, the steady voltage is a voltage kept to a constant potential. The steady voltage may be positive or negative. The value of the steady voltage is indicated by Vₛ (V). The steady voltage Vs is set depending on surface potential (relative to the ground) of the surface 102a, which is an ejection head 56 side surface of the substrate 102. That is, when surface potential distribution within the surface 102a is measured, giving a maximum value of the surface potential relative to the ground by Vₘₐₓ (V), a minimum value of the potential by Vₘᵢₙ (V) (Vₘᵢₙ<Vₘₐₓ), a potential difference between the maximum value Vₘₐₓ and the minimum value Vₘᵢₙ by V_{|max-min|} (V), and a middle value between the maximum value Vₘₐₓ and the minimum value Vₘᵢₙ by V_{mid} (V), the steady voltage applying part 104a applies to the ejection electrode 58 the steady voltage Vₛ that satisfies the following expression (A).
Vₛ≦V_{mid}−V_{|max-min|}, V_{mid}+V_{|max-min|}≦Vₛ (A)

Here, the potential difference V_{|max-min|} is presented as in an equation (B) by the maximum value Vₘₐₓ and the minimum value Vₘᵢₙ, and the middle value V_{mid} satisfies the following equation (C).
V_{|max-min|}=|Vₘₐₓ−Vₘᵢₙ| (B)
V_{mid}=(Vₘₐₓ+Vₘᵢₙ)/2 (C)

The surface potential of the insulative substrate 102 is that measured by an electrostatic voltmeter before the steady voltage applying part 104a applies the steady voltage Vₛ to the ejection electrode 58. Waveforms of the steady voltage, applied by the steady voltage applying part 104a, are shown in FIGS. 19A and 19B. In FIGS. 19A and 19B, horizontal axis indicates the voltage applied to the ejection electrode 58, and vertical axis indicates the time elapsed from voltage application to the ejection electrode 58. When the steady voltage, as shown in FIGS. 19A and 19B, is applied by the steady voltage applying part 104a, an electric field is produced, which causes the surface 102a of the substrate 102 to be charged. Meanwhile, in FIG. 18, a positive and negative direction of the steady voltage applying part 104a may be reversed.

(Liquid Ejecting Method Using Liquid Ejection Mechanism, and Operation of Liquid Ejection Mechanism)

The surface potential distribution within the surface 102a of the substrate 102 is measured by an electrostatic voltmeter before the steady voltage is applied by the steady voltage applying part 104a of the ejection voltage applying unit with charging unit 104, and a maximum value Vₘₐₓ and a minimum value Vₘᵢₙ of the surface potentials are obtained from the surface potential distribution. For the maximum value Vₘₐₓ and the minimum value Vₘᵢₙ, the steady voltage Vₛ is obtained from expressions (A), (B) and (C).

While the substrate moving mechanism moves the insulative substrate 102, the head moving mechanism moves the liquid ejection head 56. Here, both of the substrate 102 and the ejection head 56 may be moved, or either one may be moved. Almost at the same time of starting movement of the substrate 102 and the ejection head 56, the voltage applied by the steady voltage applying part 104a is set to the steady voltage Vₛ and the voltage Vₛ is applied to the ejection electrode 58. When the steady voltage Vₛ is applied to the ejection electrode 58, an electric field occurs between the tip portion of the nozzle 51 and the substrate 102, whereby liquid is ejected toward the substrate 102 from the ejection opening formed at the tip portion of the nozzle 51. As shown in FIGS. 19A and 19B, when the voltage of the ejection electrode 58 relative to the ground is expressed by V(T) as a function of time T, the voltage V(T) is a constant steady voltage Vₛ, and always satisfies Vₛ in expression (A). When the steady voltage Vₛ, the waveform of which is shown by a solid line of the graph in FIG. 19A, is kept applied to the ejection electrode 58, the liquid is continuously kept ejected until the application of voltage from the steady voltage applying part 104a is ceased. While the liquid is continuously kept ejected, at least one of the substrate 102 and the ejection head 56 is moved (the ejection head 56 relatively scans the substrate 102), and therefore a line of liquid is patterned on the surface 102a of the substrate 102. Instead of the waveform of the graph in FIG. 19A, the steady voltage Vₛ of the waveform shown by a solid line of the graph in FIG. 19B may be applied to the ejection electrode 58 by the steady voltage applying part 104a.

When the nozzle 51 passes through on a spot within the surface 102a of the substrate 102, the spot is charged by the electric field produced by the ejection electrode 58, and the surface potential of the spot changes. Although the surface potential of the surface 102a has varied in spots at the time of measurement, any spot within the surface 102a changes to a constant potential because the steady voltage Vₛ applied to the ejection electrode 58 satisfies expression (A), which causes any point within the surface 102a to be changed to a constant voltage and the surface potential distribution within the surface 102a to be uniform. This uniformity allows ejected quantity of liquid to be uniform, and spot-dependent ejection failure of liquid to be prevented.

Alternatively, the surface potential distribution on the surface 102a of the substrate 102 may not be measured, and in this case, a sufficiently large steady voltage over a predicted maximum surface potential on the surface 102a may be applied to the ejection electrode 58, or a sufficiently small steady voltage under a predicted minimum surface potential may be applied to the ejection electrode 58.

### Third Embodiment

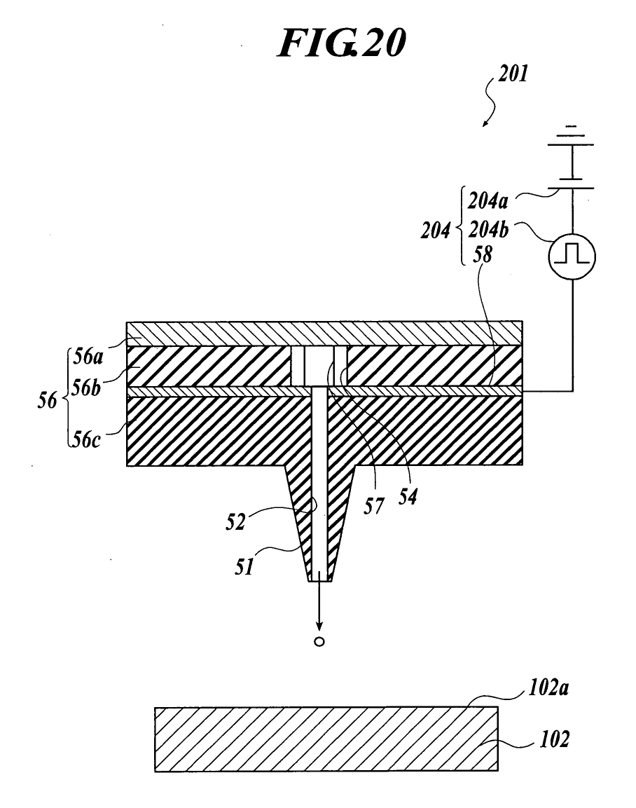

Next, a description will be given of a liquid ejection mechanism 201 according to a third embodiment of an electrostatic attraction type liquid ejection apparatus with reference to FIG. 20.

(Difference)

As shown in FIG. 20, the liquid ejection mechanism 201 is used outside the thermostat 41 as in the liquid ejection mechanism 101, and includes a liquid ejection head 56, and an ejection voltage applying unit with charging unit 204. The liquid ejection head 56 has the same construction as in the second embodiment, but the ejection voltage applying unit with charging unit 204 differs from that of the second embodiment. While the ejection voltage applying unit with charging unit 104 in the second embodiment applies a steady voltage, the ejection voltage applying unit with charging unit 204 in the third embodiment applies a pulse voltage.

The ejection voltage applying unit with charging unit 204 includes a steady voltage applying part 204a for always applying to the ejection electrode 58 a constant bias voltage V₁ (V) relative to the ground (the bias voltage V₁ may be positive, negative or zero), and a pulse voltage applying part 204b for applying to the ejection electrode 58 a pulse voltage V₂ (V) (the pulse voltage V₂ may be positive or negative) superposing on the bias voltage V₁. When the voltage of the ejection electrode 58 relative to the ground is expressed by V(T) as a function of time T, the voltage V(T) is a constant bias voltage V₁ when the pulse voltage applying part 204b is in OFF state, and a (bias voltage V₁+pulse voltage V₂) constantly when the pulse voltage applying part 204b is in ON state.

Here, the unit 204 is so set that at least either of the bias voltage V₁ or (bias voltage V₁+pulse voltage V₂) satisfies the voltage Vₛ in expression (A).

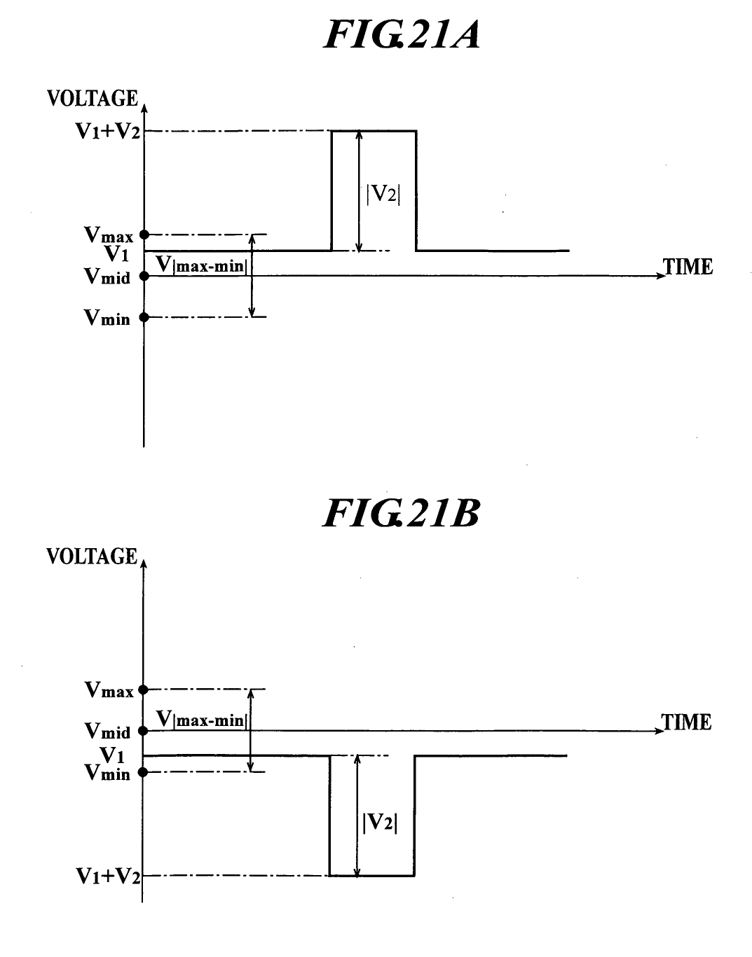

Specifically, when the bias voltage V₁ is set to more that the minimum value Vₘᵢₙ and less than the maximum value Vₘₐₓ, then the waveform of the voltage V(T) of the ejection electrode 107 follows a solid line of the graph in FIG. 21A or in FIG. 21B. In FIGS. 21A and 21B, ordinate indicates the voltage, and abscissa indicates the time. The waveform of the graph in FIG. 21A shows a case that the pulse voltage V₂ is set to positive, and the graph in FIG. 21B shows a case that the pulse voltage V₂ is set to negative. In this case, the bias voltage V₁ does not satisfy the voltage Vₛ in expression (A), therefore the pulse voltage V₂ has to be set so that (bias voltage V₁+pulse voltage V₂) satisfies the voltage Vₛ in expression (A).

In the graph of FIG. 21A, the maximum value of the voltage V(T) is (bias voltage V₁+pulse voltage V₂) and the minimum value is V₁, and (bias voltage V₁+pulse voltage V₂−middle value V_{mid}) is larger than (bias voltage V₁−middle value V_{mid}). In the graph of FIG. 21B, the maximum value of the voltage V(T) is the bias voltage V₁ which is higher than the middle value V_{mid}, and the minimum value is (bias voltage V₁+pulse voltage V₂), which is lower than the middle value V_{mid}. In the graph of FIG. 21B, (middle value V_{mid}−bias voltage V₁−pulse voltage V₂) is larger than (bias voltage V₁−middle value V_{mid}).

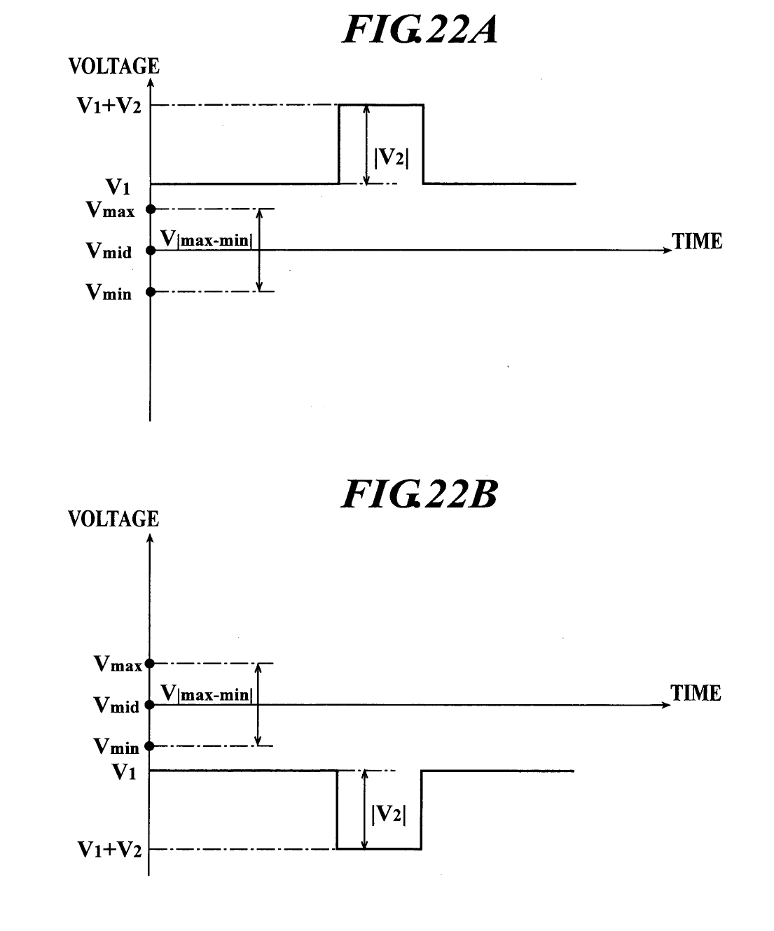

When the bias voltage V₁ is set to more than the maximum value Vₘₐₓ and the pulse voltage V₂ to positive, then a waveform of the voltage V(T) is represented as shown by a solid line in the graph of FIG. 22A. When the bias voltage V₁ is set to less than the minimum value Vₘᵢₙ and the pulse voltage V₂ to negative, then a waveform of the voltage V(T) is represented as shown by a solid line in the graph of FIG. 22B. Here, in FIGS. 22A and 22B, ordinate indicates the voltage, and abscissa indicates the time. In FIGS. 22A and 22B, when the bias voltage V₁ satisfies the voltage Vₛ in expression (A), then the pulse voltage V₂ can be given to any value, but when the bias voltage V₁ does not satisfy the voltage Vₛ in expression (A), then the pulse voltage V₂ has to be set so that (bias voltage V₁+pulse voltage V₂) satisfies the voltage Vₛ in expression (A).

In the graph of FIG. 22A, the maximum value of the voltage V(T) is (bias voltage V₁+pulse voltage V₂) and the minimum value is V₁, and (bias voltage V₁+pulse voltage V₂−middle value V_{mid}) is larger than (bias voltage V₁−middle value V_{mid}). In the graph of FIG. 22B, the maximum value of the voltage V(T) is the bias voltage V₁ (bias voltage V₁+pulse voltage V₂), and (middle value V_{mid}−bias voltage V₁−pulse voltage V₂) is larger than (middle value V_{mid}−bias voltage V₁).

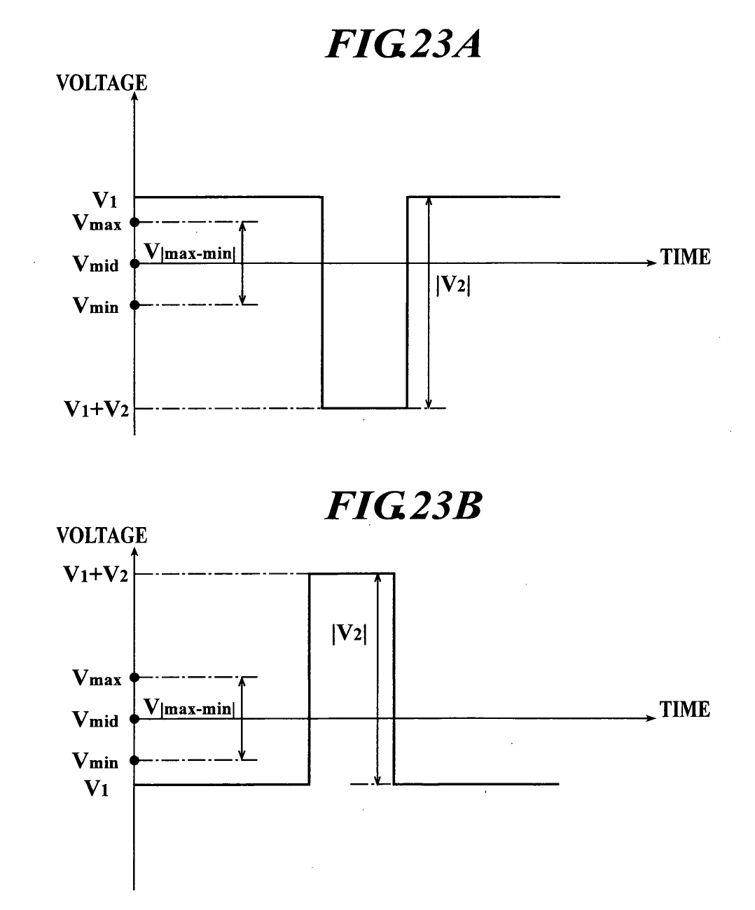

When the bias voltage V₁ is set to more than the maximum value Vₘₐₓ and the pulse voltage V₂ to negative, then a waveform of the voltage V(T) is represented as shown by a solid line in the graph of FIG. 23A. When the bias voltage V₁ is set to less than the minimum value Vₘᵢₙ and the pulse voltage V₂ to positive, then a waveform of the voltage V(T) is represented as shown by a solid line in the graph of FIG. 23B. Here, in FIGS. 23A and 23B, ordinate indicates the voltage, and abscissa indicates the time. In FIGS. 23A and 23B, when the bias voltage V₁ satisfies the voltage Vₛ in expression (A), then the pulse voltage V₂ can be given to any value, but when the bias voltage V₁ does not satisfy the voltage Vₛ in expression (A), then the pulse voltage V₂ has to be set so that (bias voltage V₁+pulse voltage V₂) satisfies the voltage Vₛ in expression (A).

In the graph of FIG. 23A, the maximum value of the voltage V(T) is V₁, which is higher than the middle value V_{mid}, and the minimum value is (bias voltage V₁+pulse voltage V₂), which is lower then the middle value V_{mid}. Also in the graph of FIG. 23A, either of (bias voltage V₁−middle value V_{mid}) and (middle value V_{mid}−bias voltage V₁−pulse voltage V₂) is larger than the other. On the other hand, in the graph of FIG. 23B, the maximum value of the voltage V(T) is (bias voltage V₁+pulse voltage V₂), which is higher then the middle value V_{mid}, and the minimum value is V₁, which is lower than the middle value V_{mid}. Also in the graph of FIG. 23B, either of (bias voltage V₁+pulse voltage V₂−middle value V_{mid}) and (middle value V_{mid}−bias voltage V₁) is larger than the other.

(Liquid Ejecting Method Using Liquid Ejection Mechanism, and Operation of Liquid Ejection Mechanism)

The surface potential distribution within the surface 102a of the substrate 102 is measured by an electrostatic voltmeter before voltage is applied by the steady voltage applying part 204a and the pulse voltage applying part 204b of the ejection voltage applying unit with charging unit 204, and the maximum value Vₘₐₓ and minimum value Vₘᵢₙ of the surface potentials are obtained from the surface potential distribution. For the maximum value Vₘₐₓ and the minimum value Vₘᵢₙ, the bias voltage V₁ and the pulse voltage V₂ are obtained from expressions (A), (B) and (C) so that at least either the bias voltage V₁ or (bias voltage V₁+pulse voltage V₂) satisfies the voltage Vₛ in expression (A).

While the substrate moving mechanism moves the insulative substrate 102, the head moving mechanism moves the liquid ejection head 56. Here, both of the substrate 102 and the ejection head 56 may be moved, or either one may be moved. Almost at the same time of starting movement of the substrate 102 and the ejection head 56, the steady voltage applied by the steady voltage applying part 204a is set to the bias voltage V₁ and the bias voltage V₁ is applied to the ejection electrode 58. While at least either the substrate 102 or the ejection head 56 is moved, the pulse voltage V₂ superposed on the bias voltage V₁ is applied to the ejection electrode 58. When (bias voltage V₁+pulse voltage V₂) is applied to the ejection electrode 58, liquid is ejected toward the substrate 102 as a droplet from the ejection opening formed at the tip portion of the nozzle 51 to form a dot by the droplet landed on the substrate 102. While the pulse voltage V₂ is repeatedly applied, at least one of the substrate 102 and the ejection head 56 is moved, and therefore a pattern composed of dots is formed on the surface 102a of the substrate 102.

When the nozzle 51 passes through on a certain spot within the surface 102a of the substrate 102, the spot is charged by the electric field produced by the ejection electrode 58, and the surface potential of the spot changes. Although the surface potential of the surface 102a has varied in spots at the time of measurement, any spot within the surface 102a changes to a constant potential because at least one of the bias voltage V₁ or (bias voltage V₁+pulse voltage V₂) satisfies expression (A), which causes any point within the surface 102a to be changed to a constant voltage and the surface potential distribution within the surface 102a to be uniform. This uniformity allows ejected quantity of liquid to be uniform, and spot-dependent ejection failure of liquid to be prevented.

### Fourth Embodiment

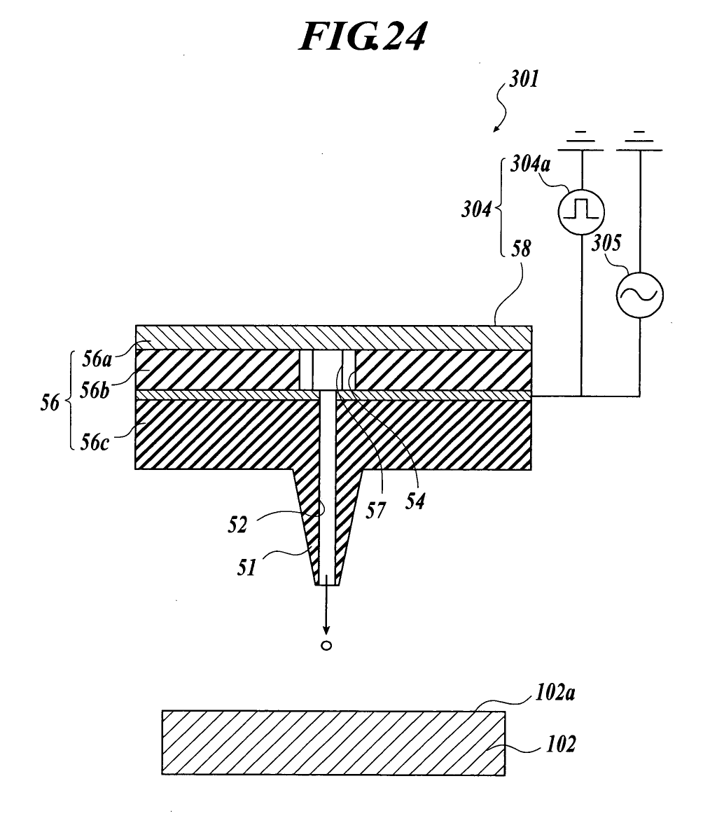

Next, a description will be given of a liquid ejection mechanism 301 according to a fourth embodiment of an electrostatic attraction type liquid ejection apparatus with reference to FIG. 24.

(Difference)

As shown in FIG. 24, the liquid ejection mechanism 301 is used outside the thermostat 41 as in the liquid ejection mechanism 101, and includes a liquid ejection head 56. The liquid ejection mechanism 301 further includes an ejection voltage applying unit 304 for applying to the ejection electrode 58 a pulse wave of ejection voltage with reference to the ground only at the time of ejection of liquid, and an AC voltage applying unit 305 as a static eliminating unit for eliminating charge on the surface 102a of the substrate 102 by applying to the ejection electrode 58 an AC voltage with the center set to 0 V before ejection of liquid. The ejection voltage applying unit 304 includes a pulse voltage applying part 304a. An ejection voltage V applied by the pulse voltage applying part 304a is large enough to eject liquid from the nozzle 51 of the ejection head 56, and theoretically obtained from the following expression (1). With such an ejection voltage, an electric field is produced between the nozzle 51 and the insulative substrate 102 to eject liquid from the ejection opening of the nozzle 51.

$$h \sqrt{\frac{γ π}{{ɛ}_{0} d}} > V > \sqrt{\frac{λ k d}{2 {ɛ}_{0}}} \qquad ( 1 )$$

where γ: liquid surface tension (N/m), ∈₀: permittivity of vacuum electric constant (F/m), d: inside diameter of nozzle (ejection opening diameter) (m), h: distance between nozzle and substrate (m), and k: proportional constant depending on nozzle shape (1.5<k<8.5).
(Liquid Ejecting Method Using Liquid Ejection Mechanism, and Operation of Liquid Ejection Mechanism)

First, in a state that liquid is not supplied to the nozzle 51, the AC voltage applying unit 305 is operated without operation of the ejection voltage applying unit 304. Next, in a state that the AC voltage applying unit 305 is operated, while the substrate moving mechanism moves the insulative substrate 102, the head moving mechanism moves the liquid ejection head 56. Here, both of the substrate 102 and the ejection head 56 may be moved, or either one may be moved.

By applying the AC voltage to the ejection electrode 58, the surface 102a of the substrate 102 is discharged at the portion opposing the nozzle 51. At least either one of the substrate 102 or the ejection head 51 is moved, so that all of the surface 102a is discharged to make the surface potential distribution of the surface 102a uniform.

Next, the AC voltage applying unit 305 stops the operation, and the substrate moving mechanism and the head moving mechanism also stop the operation. Thereafter, liquid is supplied to the liquid chamber 111 and the inside-nozzle flow passage 113. Then, the substrate moving mechanism again moves the substrate 102, and also the head moving mechanism moves the liquid ejection head 56. Here, both of the substrate 102 and the ejection head 56 may be moved, or either one may be moved. The ejection voltage applying unit 304 is operated, and while at least one of the substrate 102 and the ejection head 56 is moved, the ejection voltage is applied to the ejection electrode 58 at predetermined timing from ejection voltage applying unit 304. When the ejection voltage is applied to the ejection electrode 58, liquid is ejected toward the substrate 102 as a droplet from the ejection opening formed at the tip portion of the nozzle 51 to form a dot by the droplet landed on the substrate 102. Thus, while the ejection voltage is repeatedly applied, at least one of the substrate 102 and the ejection head 56 is moved, and therefore a pattern composed of dots is formed on the surface 102a of the substrate 102. Here, since the surface 102a of the substrate 102 is discharged and has a uniform surface potential distribution, ejected quantity of liquid can be constant and position-dependent liquid ejection failure can be prevented.

In the above description, the ejection electrode 58 is an object to be applied the AC voltage by the AC voltage applying unit 305 and also used as an electrode for static elimination. But there may be provided with another electrode for static elimination (another electrode may be preferably needle-shaped) near the nozzle 51 as an object of the AC voltage.

The ejection voltage applying unit 304 applies a pulse wave of ejection voltage at a predetermined timing, but instead may always apply to the ejection electrode 58 a constant voltage (namely, steady voltage). In this case, the nozzle 51 continues ejecting liquid as long as the ejection voltage is kept applied to the ejection electrode 58.

### Fifth Embodiment

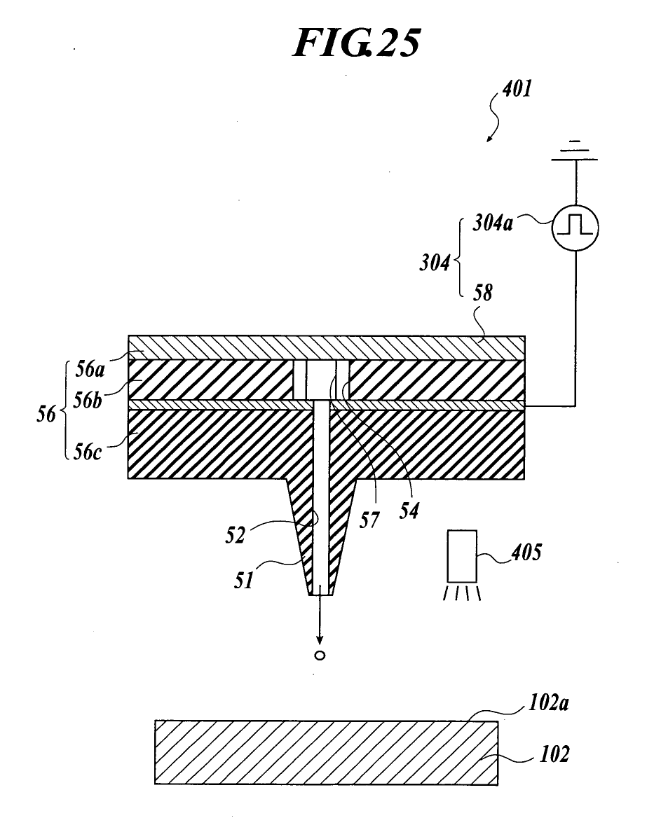

Next, a description will be given of a liquid ejection mechanism 401 according to a fifth embodiment of an electrostatic attraction type liquid ejection apparatus with reference to FIG. 25.

(Difference)

As shown in FIG. 25, the liquid ejection mechanism 401 also includes the liquid ejection head 56, and the ejection voltage applying unit 304 as in the liquid ejection mechanism 301.

The liquid ejection mechanism 401, instead of the AC voltage applying unit 305, further includes a static eliminator 405 arranged opposing to the surface 102a of the insulative substrate 102 for eliminating static electricity from the surface 102a. The static eliminator 405 may be provided so as to move together with the ejection head 56, to move, separately from the ejection head 56, along a surface perpendicular to the direction toward which liquid is ejected from the ejection head 56, or to be fixed without moving. The static eliminator 405 may be of a corona discharge type using local dielectric breakdown of air due to electric field concentration, of a soft X-ray illumination type using photoelectron emission due to inelastic scattering of photons of soft X-rays (faint X-ray), of an ultraviolet illumination type using electron emission due to photon absorption of ultraviolet rays, or of a radioactive ray illumination type using ionization by α rays from a radioactive isotope. When the static eliminator 405 is of a corona discharge type, it may be of a self discharging type, or of a voltage applying type that generates corona discharge by application of a voltage. Further, the static eliminator 405 may be preferably of a draft-free type that does not generate an aerial current accompanied by discharge action. Here, the corona discharge type static eliminator may not be of a AC power-frequency type, but be preferably of a high-frequency corona discharge type that generates a lot of positive ions and negative ions with well balance by applying to discharge needles a high voltage with extremely higher frequency (about 30 kHz or more) than the power-frequency to generate corona discharge. It is also preferable to bring the electrode close to the insulative substance 102 to impart an ionized atmosphere to the substrate 102 rather than blowing an ionized flow by pressured air.

(Liquid Ejecting Method Using Liquid Ejection Mechanism, and Operation of Liquid Ejection Mechanism)

First, in a state that liquid is not supplied to the nozzle 51, all of the surface 102a of the insulative substrate 102 is discharged by the static eliminator 405 without operation of the ejection voltage applying unit 304. This makes the surface potential distribution of the surface 102a uniform.

Next, liquid is supplied to the liquid chamber 111 and the inside-nozzle flow passage 113. Then, the substrate moving mechanism moves the insulative substrate 102, and the head moving mechanism moves the liquid ejection head 56. Here, both of the substrate 102 and the ejection head 56 may be moved, or either one may be moved. And, the ejection voltage applying unit 304 is operated, and while at least one of the substrate 102 and the ejection head 56 is moved, the ejection voltage is applied to the ejection electrode 58 at predetermined timing from ejection voltage applying unit 304. When the ejection voltage is applied to the ejection electrode 58, an electric field is produced between the nozzle 51 and the substrate 102, and liquid is ejected toward the substrate 102 as a droplet from the ejection opening formed at the tip portion of the nozzle 51 to form a dot by the droplet landed on the substrate 102. Thus, while the ejection voltage is repeatedly applied, at least one of the substrate 102 and the ejection head 56 is moved, and therefore a pattern composed of dots is formed on the surface 102a of the substrate 102. Here, since the surface 102a of the substrate 102 is discharged and has a uniform surface potential distribution, ejected quantity of liquid can be constant and position-dependent liquid ejection failure can be prevented.

The ejection voltage applying unit 304 applies a pulse wave of ejection voltage at a predetermined timing, but instead may always apply to the ejection electrode 58 a constant voltage (namely, steady voltage). In this case, the nozzle 51 continues ejecting liquid as long as the ejection voltage is kept applied to the ejection electrode 58.

### Sixth Embodiment

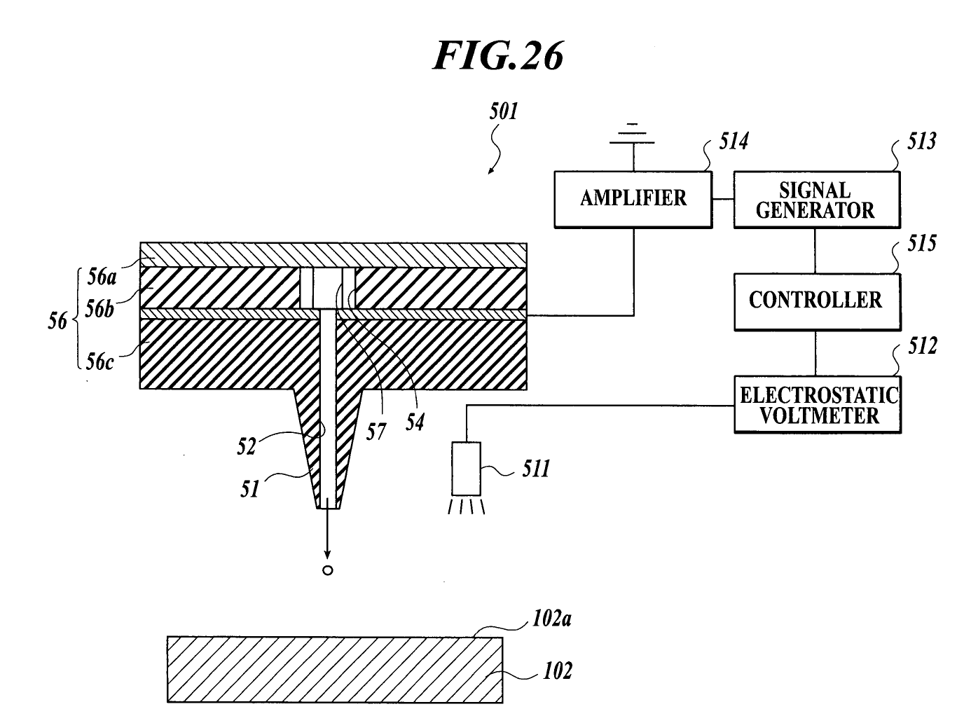

Next, a description will be given of a liquid ejection mechanism 501 according to a sixth embodiment of an electrostatic attraction type liquid ejection apparatus with reference to FIG. 26.

As shown in FIG. 26, the liquid ejection mechanism 501 also includes the liquid ejection head 56, and further includes an electrostatic voltmeter 512 as a detecting unit having a probe 511 for detecting the potential of each point on the surface 102a of the substrate 102, a signal generator 513 for outputting a pulse signal to apply a pulse voltage to the ejection electrode 58 of the ejection head 56, an amplifier 514 for amplifying the pulse signal output from the signal generator 513 by a given factor to apply to the ejection electrode 58, a controller 515, and a moving mechanism (not shown) for positioning the probe 511 to a plurality of positions to be sampled on the surface 102a of the substrate 102, the controller 515 for controlling the signal generator 513 to supply a voltage of a signal waveform thereto, at least a part of the voltage value of the signal waveform satisfying the voltage Vₛ (V) of the following expression (A), assuming that the maximum value and the minimum value of the surface potentials of the insulative substance, detected by, are Vₘₐₓ (V) and Vₘᵢₙ (V), respectively.

With the probe 511 spaced apart from and facing the surface 102a of the substrate 102, the electrostatic voltmeter 512 can detect the potential of a tiny area of corresponding position. Therefore, in the liquid ejection mechanism 501, the moving mechanism positions the probe 511 to each detecting spot, which is innumerably dotted and separated apart from each other by a unit of tiny distance, to detect the potential for every spot. The detected potential of each spot is output to the controller. Here, the moving mechanism may have a moving unit for moving the substrate 102 and a moving unit for moving the probe 511 in a direction different from that of the substrate in cooperation with each other, or may move the substrate to every spot by moving the probe or the substrate only.

The controller 515 is a control circuit having a chip storing a program to control the signal generator. The controller 515 identifies the maximum value Vₘₐₓ and the minimum value Vₘᵢₙ of the surface potentials of the substrate 102 from the output of the electrostatic voltmeter 512. Further, the controller 515 calculates the range of Vₛ from expressions (A), (B) and (C) using these Vₘₐₓ and Vₘᵢₙ to identify a constant value Vₛ satisfying the range. As one example of this identifying method, in case of identifying Vₛ from a condition Vₛ≦V_{mid}−V_{|max-min|} of expression (A), Vₛ is identified by Vₛ=V_{mid}−V_{|max-min|}−a (a is a constant set in advance).

The controller further controls the output of the signal generator 513 such that a pulse voltage applied to the ejection electrode 58 can be the identified Vₛ by calculation process, the pulse voltage being an output signal of the signal generator 513 amplified by the amplifier 514.

In the liquid ejection mechanism 501, the process described above allows ejection of droplets by an appropriate pulse voltage without previous measurement in another process for the insulative substrate 102, the surface potential distribution of which is unknown. This process allows formation of dots at a desired size. Further, in case of plural times of ejection onto such a substrate 102, influence from the surface potential of the substrate is suppressed, and uniform dot formation can be achieved.

Alternatively, instead of the above-described signal generator 513 for outputting the pulse voltage, there may be used the steady voltage applying part 104a, shown in FIG. 18, to continuously apply a constant voltage.

Instead of the above-described signal generator 513 for outputting the pulse voltage, there may be also used the ejection voltage applying unit with charging unit 204, shown in FIG. 20, for applying a pulse voltage superposed on a bias voltage. In this case, the controller 515 preferably controls the ejection voltage applying unit with charging unit 204 so that the superposed voltage value may satisfy the conditional expression (A).

### APPLIED EXAMPLE 1

(Test for Obtaining Relationship between Surface Resistance of Substrate and Dispersion of Deposited Diameter of Droplets)

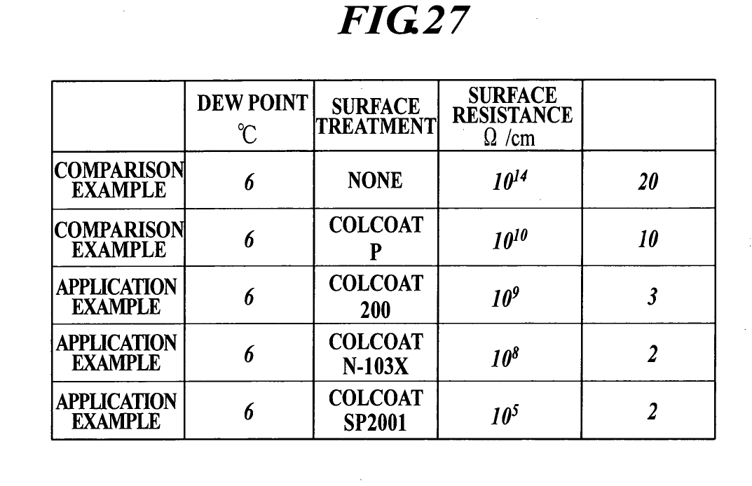

FIG. 27 is a chart showing the relationship between surface resistance of a substrate and deviation rate for dispersion of deposited diameters of droplets. This test was carried out under the following conditions: a dew point is 6 degrees centigrade; a nozzle having the same construction of the liquid ejection mechanism 50 and made of glass with a nozzle diameter of 1 μm; the distance between the tip portion of the nozzle and the substrate K is 100 μm; and for each surface resistance of the substrate K adjusted to 10¹⁴, 10¹⁰, 10⁹, 10⁸, and 10⁵ Ω/cm². Each surface resistance of the substrate K is adjusted by coating (1) without coating, (2) antistatic agent COLCOAT P™ (made at Colcoat Inc.), (3) antistatic agent COLCOAT 200™ (made at Colcoat Inc.), (4) antistatic agent COLCOAT N-103X™ (made at Colcoat Inc.), (5) antistatic agent COLCOAT SP2001™ (made at Colcoat Inc.).

Using metal paste as solution (Silver Nano Paste™ made at Harima Chemicals, Inc.), and using the same rectangular wave under conditions of 350 V as an ejection voltage, 10 Hz as an ejection frequency with 50% duty, droplets was ejected to 1,000 points. Every deposited diameter is measured, and there was calculated a deviation rate (standard deviation/mean value) of dispersion of the diameters.

According to the test described above, it has been observed that; when the surface resistance is reduced to 10⁹ Ω/cm², the deviation rate is abruptly reduced (⅓ or less of that for 10⁹ Ω/cm²), and with less surface resistance than this, the deposited diameter is remarkably stabilized.

### APPLIED EXAMPLE 2

(Test for Obtaining Relationship among Dew Point, Surface Potential Distribution of Substrate, Ejection Voltage and Deviation Rate for Dispersion of Deposited-Droplet Diameters)

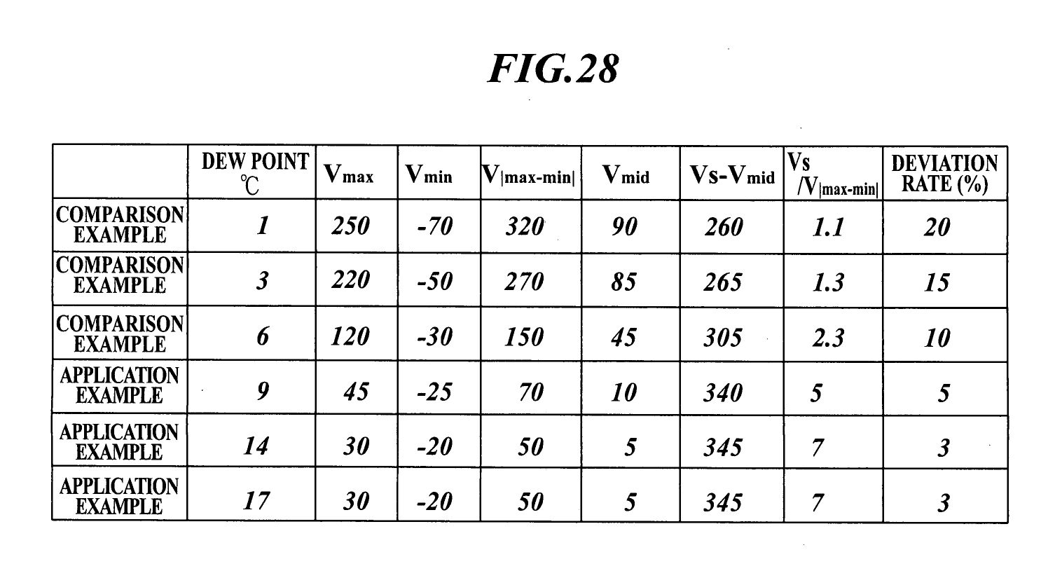

FIG. 28 is a chart showing the relationship among a dew point, surface-potential distribution of a substrate, ejection voltage and deviation rate for dispersion of deposited diameters of droplets. This test was carried out under the following conditions: ambient temperature is 23 degrees centigrade; a nozzle having the same construction of the liquid ejection mechanism 50 and made of glass with a nozzle diameter of 1 μm; the distance between the tip portion of the nozzle and the substrate K is 100 μm; and for each dew point of the glass-made substrate K adjusted to 1, 3, 6, 9, 14 and 17 degrees centigrade.

The surface potential distribution at each dew point is measured with respect to each point within the surface of the glass-made substrate K using an electrostatic voltmeter (Model 347™ made by TREK Inc.). Here, the surface potential is measured at each of 10,000 points on a grid having 100 vertical points and 100 horizontal points by 3 mm space in vertical and horizontal directions. There are shown in FIG. 28 for the result a maximum potential Vₘₐₓ out of 10,000 points, a minimum potential Vₘᵢₙ out of 10,000 points, an absolute value of the difference between the maximum and the minimum potentials V_{|max-min|}, and a mean value V_{mid} of the maximum and minimum potentials.

Using metal paste as solution (Silver Nano Paste™ made by Harima Chemicals, Inc.), and using the same rectangular wave under conditions of 350 V as an ejection voltage, 10 Hz as an ejection frequency with 50% duty, droplets was ejected to 1,000 points. Every deposited diameter is measured, and there was calculated a deviation rate (standard deviation/mean value) of dispersion of the diameters.

According to the test described above, it has been observed that; when the dew point rises to 9 degrees centigrade, the deviation rate is abruptly reduced (½ of that for 6 degrees centigrade), and with more than this dew point, the deposited diameter is remarkably stabilized.

That is, it has been proved that setting a dew point to 9 degrees centigrade or more makes a remarkable effect on stabilizing the diameter of ejected droplets.

Next, the relationship among the dew point, the potential distribution and the ejection voltage will be verified. There is described from the second embodiment and later conditions of reducing influence from potential distribution at the substrate k side due to the surface distribution and the ejection voltage. That is, when the condition of expression (A) (refer to the description of the second embodiment) is satisfied for the Vₘₐₓ, Vₘᵢₙ, V_{|max-min|}, V_{mid}, then the influence from the potential distribution at the substrate K side is reduced.

At dew points of 1 and 3 degrees centigrade, the ejection voltage Vₛ does not satisfy expression (A), therefore a large deviation rate of the deposited-liquid diameters results because of the influence from potential distribution at the substrate k side.

At a dew point of 6 degrees centigrade, the ejection voltage Vₛ satisfies expression (A), but Vₛ/V_{|max-min|} is less than 5, and therefore the deviation rate is large.

On the other hand, in three applied examples satisfying the dew-point condition, dispersion of the surface potentials is reduced and the ejection voltage Vₛ satisfies expression (A) as well as Vₛ/V_{|max-min|} is 5 and more. Resultantly, the deviation rate of the deposited-liquid diameters is reduced.

### APPLIED EXAMPLE 3

(Test for Obtaining Relationship among Dew Point, Surface potential Distribution of Substrate, Ejection Voltage and Deviation Rate for Dispersion of Deposited-Droplet Diameters)

In the applied example, three patterns with the bias voltage V₁ and the pulse voltage V₂ changed are tested to compare dispersion of diameters of deposited droplets. This test was carried out in the same manner as in the second embodiment in the atmosphere with a dew point of 14 degrees centigrade in which a good result was obtained as shown in FIG. 28 and under the same environment and conditions using the same glass substrate K. That is, the following conditions are the same as those in the second embodiment: the maximum value and minimum value of the surface potentials of the substrate K, the solution, the number of ejected points, applied frequency, the method for detecting the potential distribution, and the method for calculating the deviation rate of the deposited diameters.

In the test, the bias voltage V₁ was continuously kept applied to the ejection electrode, and the bias voltage V₁ was superposed only at the time of ejection instantaneously.

In a first pattern, the bias voltage V₁ was set to 0 V and the pulse voltage V₂ to 350 V to obtain the same ejection voltage Vs (=V₁+V₂) as in the second applied example. In a second pattern, the bias voltage V₁ was set to −50 V and the pulse voltage V₂ to 350 V, and the bias voltage V₁ to −50 V and the pulse voltage V₂ to 550 V in a third pattern.

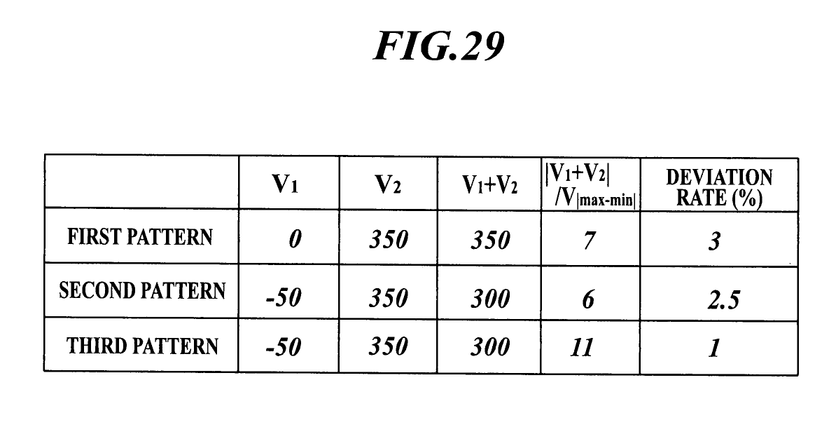

FIG. 29 is a chart showing the relationship between a bias voltage and a pulse voltage and dispersion of deposited-droplet diameters under a good dew-point environment. The chart of FIG. 29 shows bias voltage V₁, pulse voltage V₂, V₁+V₂, |V₁+V₂|/V_{|max-min|}, and deviation rate of the deposited diameter for each pattern. A description will be given of the relationship between a bias voltage and a pulse voltage and dispersion of deposited-droplet diameters under a good dew-point environment, taking into account the relationship with Vₘₐₓ, Vₘᵢₙ, V_{|max-min|} and V_{mid}. Here, as to Vₘₐₓ, Vₘᵢₙ, V_{|max-min|} and V_{mid}, description in a row with a dew point of 14 degrees centigrade in FIG. 28 will be referred to.

Assuming the first pattern to be a standard, in the second pattern, a value V₁+V₂, namely Vs, is reduced, but the bias voltage V₁ is lower than Vₘᵢₙ, so that this state corresponds to that of FIG. 23B of the third embodiment described before and the deviation rate was observed to be improved.

In the third pattern, |V₁+V₂|/V_{|max-min|} is more than 10, and the deviation rate was observed to be improved.

### APPLIED EXAMPLE 4

The invention will be more specifically explained below with a description of an applied example.

There was employed in an applied example 4 an electrostatic attraction type liquid ejection apparatus 101 according to the second embodiment. There were used Silver Nano Paste™ made by Harima Chemicals, Inc. as the liquid supplied to the nozzle 110, the nozzle 110 made of glass having an inside diameter (diameter of the ejection opening 112) of 2 μm, and a glass board as the insulative substrate 102 having a distance of 100 μm between the tip portion of the nozzle 110 and the surface 102a thereof.

Next, using an electrostatic voltmeter (Model 347™ made at TREK Inc.), the surface potential at each point within the surface of the glass board used as the substrate 102 was measure to obtain the surface potential distribution. Here, the surface potential is measured at each of 10,000 points on a grid having 100 vertical points and 100 horizontal points by 3 mm space in vertical and horizontal directions. As a result, a maximum value Vₘₐₓ out of the surface potentials of the glass board was 400 V, a minimum value Vₘᵢₙ was 100 V, the middle value V_{mid} was 250 V, and the potential difference V_{|max-min|} was 300 V.

By setting the voltage Vₛ to conditions shown in Table 1, the voltage Vₛ being applied by the steady voltage applying part 104a of the ejection voltage applying unit with charging unit 104, liquid was ejected from the nozzle 110 toward the glass board, and a line of liquid was patterned on the surface of the glass board with the nozzle 110 moved. The deviation of widths of the line patterned on the surface of the glass board was measured. The deviation of widths of the line is also shown in Table 1. Here, the deviation was obtained by observing the line with a laser microscope (made by TEYENCE Corporation), measuring the line width at arbitrary points along the line by image processing, and being calculated from a mean value of the line widths, a maximum value and a minimum value.

TABLE 1

| | | | | Deviation of |
|---|---|---|---|---|
| | Vₛ | Vₛ − V_{mid} | Vₛ/V_{\|max-min\|} | Line Width |
| Condition (a) | 600 V | 350 V | 2.0 | 10% |
| Condition (b) | 1000 V | 750 V | 3.3 | 7% |
| Condition (c) | 400 V | 150 V | 1.3 | 55% |

As understood from Table 1, in conditions (a) and (b), the voltage Vₛ satisfies expression (A), therefore condition (a) had a small deviation of line width of 10%, and condition (b) also had small deviation of 7%. In condition (c), the voltage Vₛ does not satisfy expression (A), therefore the deviation of line width was large of 55%. Thus, conditions (a) and (b) allowed ejection quantity of droplets to be constant, and position-dependent ejection failure of droplets to be prevented.

### APPLIED EXAMPLE 5

There was employed in an applied example 5 an electrostatic attraction type liquid ejection apparatus 101 according to the second embodiment. There were used Silver Nano Paste™ made by Harima Chemicals, Inc. as the liquid supplied to the nozzle 110, the nozzle 110 made of glass having an inside diameter (diameter of the ejection opening 112) of 2 μm, and a glass board as the insulative substrate 102 having a distance of 100 μm between the tip portion of the nozzle 110 and the surface 102a thereof.

Next, using an electrostatic voltmeter as in the applied example 4, the surface potential at each point within the surface of the glass board used as the substrate 102 was measure to obtain the surface potential distribution. As a result, a maximum value Vₘₐₓ out of the surface potentials of the glass board was 70 V, a minimum value Vₘᵢₙ was −20 V, the middle value V_{mid} was 25 V, and the potential difference V_{|max-min|} was 90 V.

By setting the voltage Vₛ to conditions shown in Table 2, the voltage Vₛ being applied by the steady voltage applying part 104a of the ejection voltage applying unit with charging unit 104, liquid was ejected from the nozzle 110 toward the glass board, and a line of liquid was patterned on the surface of the glass board with the nozzle 110 moved. As in the applied example 1, the deviation of widths of the line patterned on the surface of the glass board was measured. The deviation of widths of the line is also shown in Table 2. Vₛ/V_{|max-min|} was also obtained and shown in Table 2.

TABLE 2

| | | | Deviation of |
|---|---|---|---|
| | Vₛ | Vₛ/V_{\|max-min\|} | Line Width |
| Condition (d) | 400 V | 4.4 | 6% |
| Condition (e) | 600 V | 6.7 | 3% |
| Condition (f) | 1000 V | 11.1 | 1% |

As understood from Table 2, in conditions (d), (e) and (f), the voltage Vₛ satisfies expression (A), therefore condition (d) had a small deviation of line width of 6%, condition (e) had a small deviation of 3%, and condition (f) had a small deviation of 1%. As Vₛ/V_{|max-min|} becomes larger, deviation of line width becomes smaller, and therefore it has been found that Vₛ/V_{|max-min|} is preferably 5% or more, and more preferably 10% or more.

### APPLIED EXAMPLE 6

There was employed in an applied example 6 an electrostatic attraction type liquid ejection apparatus 201 according to the third embodiment. There were used Silver Nano Paste™ made at Harima Chemicals, Inc. as the liquid supplied to the nozzle 110, the nozzle 110 made of glass having an inside diameter (diameter of the ejection opening 112) of 2 μm, and a glass board as the insulative substrate 102 having a distance of 100 μm between the tip portion of the nozzle 110 and the surface 102a thereof.

Next, using an electrostatic voltmeter as in the applied example 1, the surface potential at each point within the surface of the glass board used as the substrate 102 was measure to obtain the surface potential distribution. As a result, a maximum value Vₘₐₓ out of the surface potentials of the glass board was 70 V, a minimum value Vₘᵢₙ was −20 V, the middle value V_{mid} was 25 V, and the potential difference V_{|max-min}| was 90 V.

By setting the bias voltage V₁ and the pulse voltage V₂ to each condition shown in Table 3, the voltage V₁ being applied by the steady voltage applying part 204a of the ejection voltage applying unit with charging unit 204, and the voltage V₂ being applied by the pulse voltage applying part 204b, the pulse voltage V₂ was repeatedly applied 250 times with the nozzle 110 moved, whereby liquid as a droplet was ejected 250 times from the nozzle 110 toward the glass board to form a pattern on the surface of the glass board with droplet dots. The deviation rate of diameter of dots patterned on the surface of the glass board was obtained. The deviation rate of dot diameters is also shown in Table 3. As to the deviation rate, the dots were observed by a laser microscope (made by KEYENCE Corporation), each dot was measured by image processing from a dot area assumed to be round, standard deviation and a mean value of measured diameters were obtained, and obtained the deviation rate with the standard deviation divided by the mean value.

TABLE 3

| | | | | Deviation |
|---|---|---|---|---|
| | V₁ | V₂ | V₁ + V₂ | Rate |
| Condition (g) | 0 V | 350 V | 350 V | 12% |
| Condition (h) | 100 V | 350 V | 450 V | 8% |
| Condition (i) | −450 V | 350 V | −100 V | 8% |
| Condition (j) | −100 V | 350 V | 250 V | 5% |

As understood from Table 3, in any one of conditions (g), (h), (i) and (j), at least either the bias voltage V₁, which is the minimum value of the voltage applied to the ejection electrode 107, or the maximum value (bias voltage V₁+pulse voltage V₂) satisfies expression (A). Condition (g) had a small deviation rate of dot diameter of 12%, condition (h) a smaller deviation rate of 8%, condition (i) a small deviation rate of 8%, and condition (j) a much smaller deviation rate of 5%. Thus, conditions (g) to (j) allowed ejection quantity of droplets to be constant, and position-dependent ejection failure of droplets to be prevented. Here, the reason why the deviation rate in condition (g) is larger than those in conditions (h)-(j) is considered to be that the bias voltage V₁ is larger than the minimum value Vₘᵢₙ of the surface potential and smaller than the maximum value Vₘₐₓ. In order to make the deviation rate of dot diameter smaller, it is understood that the pulse voltage applied to the ejection electrode 107 is not the waveforms as shown in FIGS. 21A and 21B but preferably the waveforms as shown in FIGS. 22A and 22B or 23A and 23B. The deviation rate in condition (j) was smallest, because (V₁+V₂) was larger than V_{mid}, and V₁ was smaller than V_{mid}.

### APPLIED EXAMPLE 7

There was employed in an applied example 7 an electrostatic attraction type liquid ejection apparatus 201 according to the third embodiment. There were used Silver Nano Paste™ made at Harima Chemicals, Inc. as the liquid supplied to the nozzle 110, the nozzle 110 made of glass having an inside diameter (diameter of the ejection opening 112) of 2 μm, and a glass board as the insulative substrate 102 having a distance of 100 μm between the tip portion of the nozzle 110 and the surface 102a thereof.

Next, using an electrostatic voltmeter as in the applied example 4, the surface potential at each point within the surface of the glass board used as the substrate 102 was measure to obtain the surface potential distribution. As a result, a maximum value Vₘₐₓ out of the surface potentials of the glass board was 70 V, a minimum value Vₘᵢₙ was −20 V, the middle value V_{mid} was 25 V, and the potential difference V_{|max-min|} was 90 V.

By setting the bias voltage V₁ and the pulse voltage V₂ to each condition shown in Table 4, the voltage V₁ being applied by the steady voltage applying part 204a of the ejection voltage applying unit with charging unit 204, and the voltage V₂ being applied by the pulse voltage applying part 204b, the pulse voltage V₂ was repeatedly applied 250 times with the nozzle 110 moved, whereby liquid as a droplet was ejected 250 times from the nozzle 110 toward the glass board to form a pattern on the surface of the glass board with droplet dots. The deviation rate of diameter of dots patterned on the surface of the glass board was obtained as in the applied example 3. The deviation rate of dot diameters is also shown in Table 4. There is also obtained and shown in Table 4 a ratio of an absolute value of a maximum value of the voltage or an absolute value of a minimum value (namely, |V₁| or |V₁+V₂|) to V_{|max-min|} (namely, |V₁+V₂|/V_{|max-min|}).

TABLE 4

| | | | | \|V₁ + V₂\|/ | Deviation |
|---|---|---|---|---|---|
| | V₁ | V₂ | V₁ + V₂ | V_{\|max-min\|} | Rate |
| Condition (k) | −100 V | 350 V | 250 V | 2.8 | 5% |
| Condition (l) | −100 V | 600 V | 500 V | 5.6 | 2% |
| Condition (m) | −100 V | 1100 V | 1000 V | 11.1 | 0.8% |

As understood from Table 4, in any one of conditions (k), (l) and (m), at least either the bias voltage V₁, which is the minimum value of the voltage applied to the ejection electrode 107, or the maximum value (bias voltage V₁+pulse voltage V₂) satisfies expression (A). Condition (k) had a small deviation rate of dot diameter of 5%, condition (1) a smaller deviation rate of 2%, and condition (m) a much smaller deviation rate of 0.8%. Thus, conditions (k)-(m) allowed ejection quantity of droplets to be constant, and position-dependent ejection failure of droplets to be prevented. As |V₁+V₂|/V_{|max-min|} becomes larger, deviation rate becomes smaller, and therefore it has been found that |V₁+V₂|/V_{|max-min|} is preferably 5 or more, and more preferably 10 or more.

### APPLIED EXAMPLE 8

There was employed in a condition (n) of an applied example 8 an electrostatic attraction type liquid ejection apparatus 301 according to the fourth embodiment. In conditions (o), (p), (q) and (r), an electrostatic attraction type liquid ejection apparatus 401 according to the fifth embodiment was employed. In a condition (s), there was employed an electrostatic attraction type liquid ejection apparatus 401 without the static eliminator 405 shown in the fifth embodiment. In any conditions (n)-(r), there were used Silver Nano Paste™ made at Harima Chemicals, Inc. as the liquid supplied to the nozzle 110, the nozzle 110 made of glass having an inside diameter (diameter of the ejection opening 112) of 2 μm, and a glass board as the insulative substrate 102 having a distance of 100 μm between the tip portion of the nozzle 110 and the surface 102a thereof.

Using an electrostatic voltmeter as in the applied example 4, the surface potential at each point within the surface of the glass board used as the substrate 102 was measure to obtain the surface potential distribution. As a result, a maximum value Vₘₐₓ out of the surface potentials of the glass board was 300 V, a minimum value Vₘᵢₙ was −100 V, the middle value V_{mid} was 100 V, and the potential difference V_{|max-min|} was 400 V.

In condition (n), while an AC voltage having ±500 V and a frequency of 1 kHz was applied to the ejection electrode 107 from an AC voltage applying unit 305, the entire surface of the glass board was discharged with the glass board scanned by the liquid ejection head 103.

In condition (o), there was used as the static eliminator 405 a self discharging type static eliminating brush (Non Spark made by Achilles Corporation). This static eliminator 405 scanned the glass board to discharge the entire surface of the glass board.

In condition (p), there was used as the static eliminator 405 a corona discharge type and Ac voltage application method of static eliminator (SJ-S made by KEYENCE Corporation) having an AC frequency of particularly set 33 kHz. This static eliminator 405 scanned the glass board to discharge the entire surface of the glass board.

In condition (q), there was used as the static eliminator 405 a high-frequency corona discharge type and Ac voltage application method of static eliminator (Zapp made by Shishido Electrostatic Ltd.) having an AC frequency of particularly set 38 kHz. This static eliminator 405 scanned the glass board to discharge the entire surface of the glass board.

In condition (r), there was used as the static eliminator 405 a soft X-ray illumination type electrostatic remover utilizing ion generation by photo-ionization (Photoionizer made by Hamamatsu Photonics K.K.). This static eliminator 405 irradiates the glass board with soft X-rays to discharge the entire surface of the glass board.

In condition (s), electrostatic discharge was not performed.

In conditions (n)-(s), a steady voltage was applied to the ejection electrode 107 to eject liquid from the nozzle 110 toward the glass board with the nozzle 110 moved, to thereby form a line with the liquid patterned on the glass-board surface. Then, there was measured deviation of widths of the line patterned on the glass-board surface. A method for obtaining the deviation of line width was the same as in the applied example 1. The electrostatic discharge method and the result are shown in Table 5.

TABLE 5

| | | Deviation |
|---|---|---|
| | Electrostatic Discharge | of Line |
| | Method | Width |
| Condition (n) | AC voltage is applied to a | 3% |
| | nozzle electrode for | |
| | discharging | |
| Condition (o) | Self discharging method of | 70% |
| | static eliminating brush | |
| Condition (p) | Corona discharge method | 10% |
| Condition (q) | High-frequency corona | 7% |
| | discharge method | |
| Condition (r) | Soft X-ray illumination | 4% |
| | method | |
| Condition (s) | Without discharging | 90% |

As understood from Table 5, when the glass board is not discharged as in condition (s), the deviation of line width was as large as 90%. To the contrary, when the glass board was discharged as in conditions (n)-(r), the deviation of line width was smaller than that for the case that discharging was not performed. Particularly, condition (n) had a small deviation of line width of 3%, condition (p) a small deviation of 10%, condition (q) a small deviation of 7%, and condition (r) a small deviation of 4%. Thus, conditions (n)-(r) allowed ejection quantity of droplets to be constant, and position-dependent ejection failure of droplets to be prevented.

[Theoretical Explanation of Liquid Ejection Apparatus]

A description will now be given of theoretical explanation of liquid ejection and a basic example based on this. Of course, there may be applied to the embodiments described above as far as possible all contents including nozzle constructions described in the theory explained below and in the basic example, characteristics of material of each part and ejection solution, structures added to the periphery of the nozzle, control conditions associated with ejecting operation and the like.

[Unit for Reducing Ejection Voltage and for Implementing Stable Ejection of Minute Quantity of Droplet]

It has been considered to be impossible in the past to eject a droplet outside a range defined by the following expression.

$$d < \frac{{λ}_{c}}{2} \qquad ( 4 )$$

where λ_{c} is a growth wavelength (m) at a solution surface that enables ejection of a droplet from the tip portion of a nozzle by electrostatic attraction force, and obtained by λ_{c}=2πγh²/∈₀V².

$$\begin{matrix}d < \frac{μ γ {h}^{2}}{{ɛ}_{0} {V}^{2}} & ( 5 ) \\ V < h \sqrt{\frac{π λ}{{ɛ}_{0} d}} & ( 6 )\end{matrix}$$

In the invention, action of a nozzle in an electrostatic attraction type inkjet printer is reviewed, and a minute droplet can be formed by using Maxwell force or the like in an area where ejection has not been tried in the past because of its impossibility.

We have figured out approximate expressions for ejection conditions to realize reduction of driving voltage and ejection of minute quantity, which will be explained below.

A following description is applicable to the liquid ejection apparatus described in the embodiments of the invention.

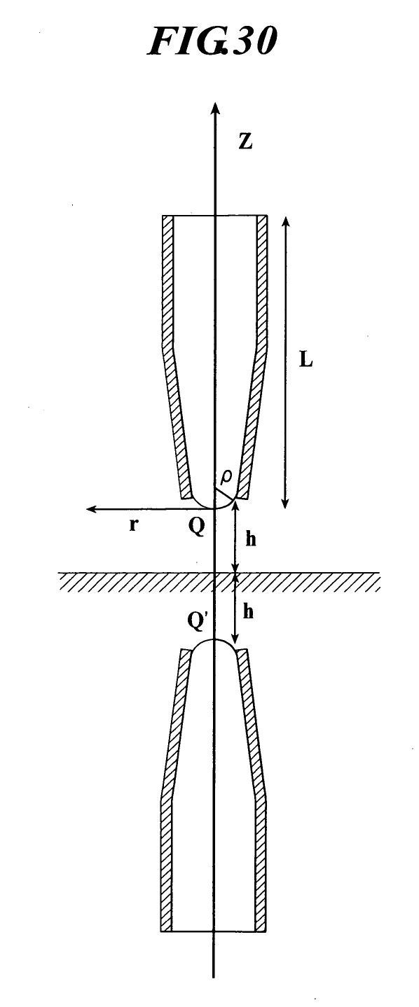

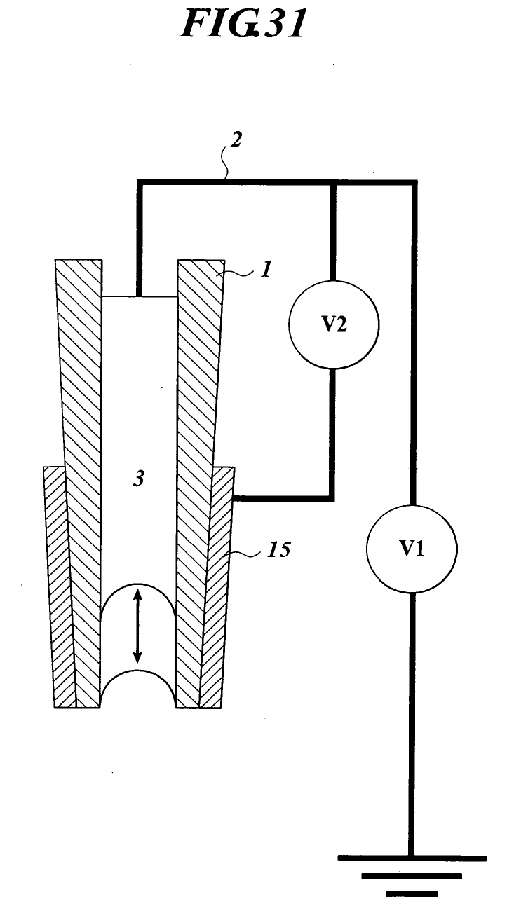

Let it be assumed that conductive solution is supplied into a nozzle having an inside diameter d and the nozzle is positioned vertically at the height h from an infinite conductive plane as a substrate. This state is shown in FIG. 30. Assuming that charge Q induced at the tip portion of the nozzle is concentrated into a hemisphere part of the nozzle tip portion and approximately represented by the following equation.
Q=2π∈₀αVd (7)
where Q: charge induced at the tip portion of the nozzle (C), ∈₀: permittivity of vacuum (F/m), ∈: permittivity of substrate (F/m), h: distance between the nozzle and the substrate (m), d: inside diameter of the nozzle (m), V: total voltage applied to the nozzle, α: proportional constant depending on a nozzle shape or the like, being 1-1.5 and particularly about 1.0 in case of d<<h.

In case that the board as a substrate is a conductive board, it is assumed that reverse charge is induced near the surface to cancel the potential due to the charge Q and this state is equivalent to a state that the charge distribution induces mirror charge Q′ having a reverse sign at a symmetrical position within the board. When the board is insulation, polarization at the surface of the board induces reverse charge at the surface side, and this state is equivalent to a state that mirror charge Q′ determined by permittivity having a reverse sign is similarly induced at a symmetrical position.

Meanwhile, assuming that the radius of curvature at the top part of a convex meniscus of the nozzle tip portion is R (m), electric field intensity at the top part of the convex meniscus E_{loc} (V/m) is given by

$${E}_{loc} = \frac{V}{k R} \qquad ( 8 )$$

where k: proportional constant, which varies according to a nozzle shape, with a value of 1.5-8.5 and about 5 in most cases (P. J. Birdseye and D. A. Smith, Surface Science, 23 (1970) 198-210).

Let it be assumed to be simply d/2=R. This corresponds to a state that surface tension causes the conductive solution to rise in a hemispherical shape at the nozzle tip portion with the same radius as the radius of the nozzle.

Let us consider balance of pressure acted on the liquid at the nozzle tip portion. First, indicating a liquid surface area at the nozzle tip portion by S m², electrostatic force Pₑ is given by

$${P}_{e} = \frac{Q}{S} {E}_{loc} \approx \frac{Q}{π {d}^{2} / 2} {E}_{loc} \qquad ( 9 )$$

From equations (7), (8) and (9) and taking α=1,

$${P}_{e} = \frac{2 {ɛ}_{0} V}{d / 2} \cdot \frac{V}{k \cdot d / 2} = \frac{8 {ɛ}_{0} {V}^{2}}{k \cdot {d}^{2}} \qquad ( 10 )$$

is obtained.

On the other hand, surface tension Pₛ of the liquid at the nozzle tip portion is given by

$${P}_{s} = \frac{4 γ}{d} \qquad ( 11 )$$

where γ is surface tension (N/m).

Condition of ejecting liquid by the electrostatic force is that the electrostatic force exceeds the surface tension, resulting in
Pₑ>Pₛ (12)

By using a sufficiently small nozzle diameter d, it is possible that the electrostatic pressure exceeds the surface tension. From this expression, the relationship between V and d is given by

$$V > \sqrt{\frac{γ k d}{2 {ɛ}_{0}}} \qquad ( 13 )$$

This gives the minimum voltage for ejection. From expressions (6) and (13), we obtain

$$h \sqrt{\frac{λ π}{{ɛ}_{0} d}} > V > \sqrt{\frac{γ k d}{2 {ɛ}_{0}}} \qquad ( 1 )$$

This expression gives the operation voltage of the invention.

Dependency of the ejection critical voltage V_{c} on a certain nozzle diameter is shown in FIG. 9, described before. It is understood from the drawing that the ejection start voltage becomes lower according as the nozzle diameter reduces, taking into account field concentration effect with use of a micro-diameter nozzle.

As in a conventional way of thinking for an electric field, that is, when considered only an electric field defined by the voltage applied to a nozzle and the distance between the nozzle and an opposing electrode, a voltage necessary for ejection increases as a nozzle becomes minute. To the contrary, when focused on local electric field intensity, it is possible to reduce the ejection voltage by making the nozzle diameter minute.

Ejection by electrostatic attraction is based on charging of liquid at the end of a nozzle. Charging speed is considered to be nearly a time constant determined by dielectric relaxation.
τ=∈/σ (2)
where ∈: permittivity of solution (F/m), σ: conductivity of solution (S/m). When assumed that relative permittivity is 10 and conductivity is 10⁻⁶ S/m, then τ=1.854×10⁻⁵ sec is obtained. Or, when a critical frequency is represented by fc Hz, fc is given by equation
f_{c}=σ/∈ (14)
For higher change of electric field than this frequency fc, the nozzle may not respond to and be impossible to eject. For above example, the critical frequency is estimated to be about 10 kHz. At this time, in case that the nozzle radius is 2 μm and the voltage is a little under 500 V, flow rate G inside the nozzle can be estimated to be 10⁻¹³ m³/s. For the liquid of above example, ejection is possible at 10 kHz, therefore minimum ejection quantity of about 10 fl (femto-liter, 1 fl: 10⁻¹⁵ l) per 1 cycle can be achieved.

As shown in FIG. 30, effect of electric field concentration and action of mirror-image force induced to the opposing board are features in each embodiment described above. Accordingly, it is not necessary, as in the prior art, for a board or a board support member to be conductive, or to apply a voltage to the board or board support member. That is, it is possible in the embodiments to use as a board an insulative glass board, a board using plastic such as polyimide, a ceramics board, a semiconductor board, or the like.

In the embodiments, for the voltage applied to the electrode, any of positive and negative voltage may be applicable.

Further, keeping the distance between the nozzle and the substrate to 500 μm or less allows easier ejection of solution. Additionally, feedback control using detection of a nozzle position (not shown) may preferably allow the nozzle position to be constant relative to the substrate.

The substrate may be mounted and held on a conductive or insulative substrate holder.

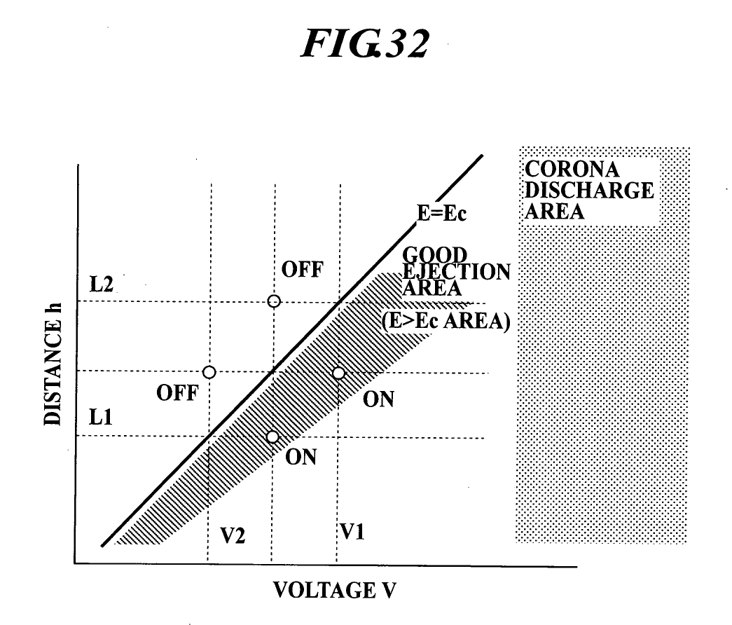

FIG. 31 shows a sectional side view of a nozzle part of a liquid ejection apparatus as one example of another basic embodiment of the invention. An electrode 15 is provided at a side surface portion of a nozzle 1 to apply a controlled voltage between the electrode and inside-nozzle solution 3. The electrode 15 is provided for controlling electro-wetting effect. When sufficient electric field is applied to insulation constructing a nozzle, electro-wetting effect is expected to occur without this electrode. However, in this basic example, this electrode positively controls the electro-wetting effect to serve as ejection control. In case that the nozzle 1 is constructed of insulation with 1 μm in thickness at the tip portion of a nozzle tube, 2 μm in inside diameter of the nozzle and 300 V of applied voltage, the electro-wetting effect occurs by about 30 P. This pressure is not enough for ejection, but serves for supplying solution to the tip portion of the nozzle, and this control electrode is conceived to be able to control ejection.

FIG. 9 shows dependency of the ejection start voltage of the invention on the nozzle diameter. There was employed as a liquid ejection device the mechanism shown in FIG. 12. It has been proved that, as the nozzle becomes minute, the ejection start voltage becomes lower thereby allowing ejection with lower voltage than conventional one.

In each above-described embodiment, conditions for ejecting liquid are function of a distance between a nozzle and a substrate (h), amplitude of applied voltage (V) and frequency of applied voltage (f), and each term has to meet a certain condition as an ejection condition. On the contrary, when any one of conditions is not met, other parameters are necessitated to be changed.

This situation will be explained referring to FIG. 32.

There exists for ejection a certain critical electric field Ec under which ejection cannot be performed. This critical electric field is a value that changes according to the nozzle diameter, surface tension and viscosity of liquid. It is difficult to eject at the value lower than Ec. At the intensity over the critical electric field Ec, that is, at the electric field intensity in which ejection is possible, there exists near proportional relationship between the nozzle-substrate distance (h) and the amplitude of applied voltage (V). When the nozzle-substrate distance is shortened, a critical applied voltage V can be reduced.

To the contrary, when the nozzle-substrate distance (h) is extremely large and the applied voltage V is resultantly large, explosion of liquid droplet, namely, burst occurs caused by corona discharge action or the like even when the same field intensity is kept.

### INDUSTRIAL APPLICABILITY

As described above, the liquid ejection apparatus and liquid ejection method according to the invention is suitable for ejection of liquid according to each of various uses: in graphic use such as normal printing, printing on a special medium (film, cloth, metal plate, etc.), wiring with liquid or paste-like conductive material, application for patterning antenna, etc.; in treatment use such as application of adhesive, sealer, etc.; in biology and medical use such as application of medicine (as in case of combining plural minute quantity of ingredients), sample for diagnosing gene, etc.

The method for forming a wiring pattern on a circuit board is suitable for forming a pattern of a circuit board.

1. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a voltage applying unit for applying the voltage to the ejection electrode;
a substrate including insulative material for receiving ejected droplets; and
an ejection atmosphere adjusting unit for keeping an atmosphere subject to ejection from the liquid ejection head, to a dew point of 9 degrees centigrade or more and less than a water saturation temperature.

2. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a voltage applying unit for applying the voltage to the ejection electrode; and
a substrate including insulative material having a surface resistance of 10⁹ Ω/cm² or less at least at the area to receive ejected droplets.

3. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a voltage applying unit for applying the voltage to the ejection electrode; and
a substrate including insulative material provided with a surface treatment layer making a surface resistance 10⁹ Ω/cm² or less at least at the area to receive ejected droplets.

4. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a voltage applying unit for applying the voltage to the ejection electrode; and
a substrate including insulative material provided with a surface treatment layer formed by coating of a surfactant at least at the area to receive ejected droplets.

5. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet; and
a voltage applying unit for applying the voltage of a signal waveform to the ejection electrode, a voltage value of the signal waveform at least partly satisfying Vₛ (V) of the following expression (A), where a maximum value of surface potentials of an insulative substrate that receives ejected droplets, is represented by Vₘₐₓ (V), and a minimum value of the same by Vₘᵢₙ (V).
Vₛ≦V_{mid}−V|ₘₐₓ₋ₘᵢₙ|, V_{mid+}V|ₘₐₓ₋ₘᵢₙ|≦Vₛ (A)
Here, V|ₘₐₓ₋ₘᵢₙ| (V) is defined by the following equation (B), and V_{mid} V) by equation (C).
V|ₘₐₓ₋ₘᵢₙ|=|Vₘₐₓ₋ₘᵢₙ| (B)
V_{mid}=(Vₘₐₓ+Vₘᵢₙ)/2 (C)

6. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a detecting unit for detecting surface potentials of an insulative substrate that receives ejected droplets; and
a voltage applying unit for applying the voltage of a signal waveform, a voltage value of the signal waveform at least partly satisfying Vₛ (V) of the following expression (A), where a maximum value of surface potentials of an insulative substrate detected by the detecting unit, is represented by Vₘₐₓ(V), and a minimum value of the same by Vₘᵢₙ (V).
Vₛ≦V_{mid}−V|ₘₐₓ₋ₘᵢₙ|, V_{mid+}V|ₘₐₓ₋ₘᵢₙ|≦Vₛ (A)
Here, V|ₘₐₓ₋ₘᵢₙ| (V) is defined by the following equation (B), and V_{mid} V) by equation (C).
V|ₘₐₓ₋ₘᵢₙ|=|Vₘₐₓ₋ₘᵢₙ| (B)
V_{mid}=(Vₘₐₓ+Vₘᵢₙ)/2 (C)

7. The liquid ejection apparatus of claim 5, wherein the signal waveform outputted by the voltage applying unit is a waveform maintaining a constant potential so as to satisfy Vₛ of aforementioned expression (A).

8. The liquid ejection apparatus of claim 5, wherein the signal waveform outputted by the voltage applying unit is a pulse voltage waveform and at least either the maximum value or the minimum value of the pulse voltage satisfies Vₛ of aforementioned expression (A).

9. The liquid ejection apparatus of claim 8, wherein a condition that the maximum value of the pulse voltage applied by the voltage applying unit is larger than and the minimum value of the pulse voltage applied by the voltage applying unit is smaller than V_{mid} is satisfied.

10. The liquid ejection apparatus of claim 5, wherein a condition that, out of a difference between the maximum value of the pulse voltage applied by the voltage applying unit and V_{mid}, and a difference between V_{mid} and the minimum value of the pulse voltage applied by the voltage applying unit, one of the difference is larger than the other difference.

11. A liquid ejection apparatus comprising:
a liquid ejection head having a nozzle for ejecting a droplet of charged solution from a tip portion;
an ejection electrode provided on the liquid ejection head, to which a voltage is applied for generating an electric field to eject the droplet;
a voltage applying unit for applying the voltage to the ejection electrode; and
a static eliminator arranged oppositely to an insulative substrate that receives ejected droplets, for discharging the insulative substrate.

12. The liquid ejection apparatus of claim 11, wherein the static eliminator is an electrode for discharging, arranged oppositely to the insulative substrate that receives the ejected droplets, and the apparatus further comprises an AC voltage applying unit to apply an AC voltage to the electrode for discharging.

13. The liquid ejection apparatus of claim 12, wherein the ejection electrode and the electrode for discharging are the same electrode.

14. The liquid ejection apparatus of claim 11, wherein the static eliminator comprises a corona discharge type static eliminator.

15. The liquid ejection apparatus of claim 11, wherein the static eliminator comprises a static eliminator which irradiates light to the insulative substrate to discharge the insulative substrate.

16. The liquid ejection apparatus of claim 1, wherein an inner diameter of the nozzle is 20 μm or less.

17. The liquid ejection apparatus of claim 16, wherein the inner diameter of the nozzle is 8 μm or less.

18. The liquid ejection apparatus of claim 17, wherein the inner diameter of the nozzle is 4 μm or less.

19. A liquid ejection method of a liquid ejection apparatus including a liquid ejection head having a nozzle for ejecting a droplet of charged solution from a tip portion, an ejection electrode provided on the liquid ejection head applied with a voltage for generating an electric field to eject the droplet, and a voltage applying unit for applying the voltage to the ejection electrode, comprising the step of:
ejecting the droplet toward a substrate including insulative material in an atmosphere which is kept to a dew point of 9 degrees centigrade or more and less than a water saturation temperature.

20. A liquid ejection method of a liquid ejection apparatus including a liquid ejection head having a nozzle for ejecting a droplet of charged solution from a tip portion, an ejection electrode provided on the liquid ejection head applied with a voltage for generating an electric field to eject the droplet, and a voltage applying unit for applying the voltage to the ejection electrode, comprising the step of:
ejecting the droplet toward a substrate including insulative material having a surface resistance of 10⁹ Ω/cm² or less at least at the area to receive ejected droplets.

21. A liquid ejection method of a liquid ejection apparatus including a liquid ejection head having a nozzle for ejecting a droplet of charged solution from a tip portion, an ejection electrode provided on the liquid ejection head applied with a voltage for generating an electric field to eject the droplet, and a voltage applying unit for applying the voltage to the ejection electrode, comprising the step of: ejecting the droplet toward a substrate including insulative material provided with a surface treatment layer making a surface resistance 10⁹ Ω/cm² or less at least at the area to receive ejected droplets.

22. A liquid ejection method of a liquid ejection apparatus including a liquid ejection head having a nozzle for ejecting a droplet of charged solution from a tip portion, an ejection electrode provided on the liquid ejection head applied with a voltage for generating an electric field to eject the droplet, and a voltage applying unit for applying the voltage to the ejection electrode, comprising the step of:
ejecting the droplet toward a substrate including insulative material provided with a surface treatment layer formed by coating of a surfactant at least at the area to receive ejected droplets.

23. A liquid ejection method comprising the steps of:
forming a surface treatment layer on a substrate including insulative material, by coating a surfactant at least at the area to receive ejected droplets;
ejecting the droplets onto the surface treatment layer of the substrate from a tip of a nozzle, by applying an ejection voltage to solution inside the nozzle; and
removing the surface treatment layer except for portions which the droplets adhered, after the ejected droplets are dried and solidified.

24. A liquid ejection method of a liquid ejection apparatus including a liquid ejection head having a nozzle for ejecting a droplet of charged solution from a tip portion, an ejection electrode provided on the liquid ejection head applied with a voltage for generating an electric field to eject the droplet, and a voltage applying unit for applying the voltage to the ejection electrode, comprising the step of:
applying the voltage of a signal waveform to the ejection electrode, a voltage value of the signal waveform at least partly satisfying Vₛ (V) of the following expression (A), where a maximum value of surface potentials of an insulative substrate that receives ejected droplets, is represented by Vₘₐₓ (V), and a minimum value of the same by Vₘᵢₙ (V).
Vₛ≦V_{mid}−V|ₘₐₓ₋ₘᵢₙ|, V_{mid+}V|ₘₐₓ₋ₘᵢₙ|≦Vₛ (A)
Here, V|ₘₐₓ₋ₘᵢₙ| (V) is defined by the following equation (B) and V_{mid} V) by equation (C).
V|ₘₐₓ₋ₘᵢₙ|=|Vₘₐₓ₋ₘᵢₙ| (B)
V_{mid}=(Vₘₐₓ+Vₘᵢₙ)/2 (C)

25. The liquid ejection method of claim 24, further comprising the step of measuring the surface potentials of the insulative substrate before applying the voltage to the ejection electrode; and obtaining the maximum value Vₘₐₓ (V) and the minimum value Vₘᵢₙ (V).

26. The liquid ejection method of claim 24, wherein the signal waveform of the voltage applied to the ejection electrode maintains a constant potential that satisfies Vₛ of aforementioned expression (A).

27. The liquid ejection method of claim 24, wherein the signal waveform of the voltage applied to the ejection electrode is a pulse voltage waveform and at least either the maximum value or the minimum value of the pulse voltage satisfies Vₛ of aforementioned expression (A).

28. The liquid ejection method of claim 27, wherein a condition that the maximum value of the pulse voltage is larger than V_{mid} and the minimum value is smaller than V_{mid} is satisfied.

29. The liquid ejection method of claim 27, wherein, out of a difference between the maximum value of the pulse voltage and V_{mid}, and a difference between V_{mid} and the minimum value of the pulse voltage, one of the difference is larger than the other difference.

30. A liquid ejection method of a liquid ejection apparatus including a liquid ejection head having a nozzle for ejecting a droplet of charged solution from a tip portion, an ejection electrode provided on the liquid ejection head, to which a voltage is applied for generating an electric field to eject the droplet, and a voltage applying unit for applying the voltage to the ejection electrode, comprising the step of:
discharging an insulative substrate before ejecting the droplet by application of ejecting voltage to the ejection electrode.

31. The liquid ejection method of claim 30, wherein the discharging the insulative substrate is performed by applying an AC voltage to an electrode for discharging, the electrode arranged oppositely to the insulative substrate.

32. The liquid ejection method of claim 31, wherein the electrode for discharging is the same as the ejection electrode.

33. The liquid ejection method of claim 30, wherein the discharging of the insulative substrate is performed by using a corona discharge type static eliminator.

34. The liquid ejection method of claim 30, wherein the discharging of the insulative substrate is performed by using a static eliminator that irradiates light to the insulative substrate.

35. The liquid ejection method of claim 19, wherein diameter of an ejection opening of the nozzle is 20 μm or less.

36. The liquid ejection method of claim 35, wherein the diameter of the ejection opening of the nozzle is 8 μm or less.

37. The liquid ejection method of claim 35, wherein the diameter of the ejection opening of the nozzle is 4 μm or less.

38. A method for forming a wiring pattern of a circuit board comprising the steps of:
employing the liquid ejection method according to claim 19; and
ejecting droplets of metal paste onto the substrate.

39. The liquid ejection apparatus of claim 6, wherein the signal waveform outputted by the voltage applying unit is a waveform maintaining a constant potential so as to satisfy Vₛ of aforementioned expression (A).

40. The liquid ejection apparatus of claim 6, wherein the signal waveform outputted by the voltage applying unit is a pulse voltage waveform and at least either the maximum value or the minimum value of the pulse voltage satisfies Vₛ of aforementioned expression (A).

41. The liquid ejection apparatus of claim 40, wherein a condition that the maximum value of the pulse voltage applied by the voltage applying unit is larger than and the minimum value of the pulse voltage applied by the voltage applying unit is smaller than V_{mid} is satisfied.

42. The liquid ejection apparatus of claim 6, wherein a condition that, out of a difference between the maximum value of the pulse voltage applied by the voltage applying unit and V_{mid}, and a difference between V_{mid} and the minimum value of the pulse voltage applied by the voltage applying unit, one of the difference is larger than the other difference.

43. The liquid ejection apparatus of claim 11, wherein an inner diameter of the nozzle is 20 μm or less.

44. The liquid ejection apparatus of claim 43, wherein the inner diameter of the nozzle is 8 μm or less.

45. The liquid ejection apparatus of claim 44, wherein the inner diameter of the nozzle is 8 μm or less.

46. The liquid ejection method of claim 25, wherein the signal waveform of the voltage applied to the ejection electrode maintains a constant potential that satisfies Vₛ of aforementioned expression (A).

47. The liquid ejection method of claim 24, wherein the signal waveform of the voltage applied to the ejection electrode is a pulse voltage waveform and at least either the maximum value or the minimum value of the pulse voltage satisfies Vₛ of aforementioned expression (A).

48. The liquid ejection method of claim 47, wherein a condition that the maximum value of the pulse voltage is larger than V_{mid} and the minimum value is smaller than V_{mid} is satisfied.

49. The liquid ejection method of claim 47, wherein, out of a difference between the maximum value of the pulse voltage and V_{mid}, and a difference between V_{mid} and the minimum value of the pulse voltage, one of the difference is larger than the other difference.

50. The liquid ejection method of claim 48, wherein, out of a difference between the maximum value of the pulse voltage and V_{mid}, and a difference between V_{mid} and the minimum value of the pulse voltage, one of the difference is larger than the other difference.

51. The liquid ejection method of claim 28, wherein, out of a difference between the maximum value of the pulse voltage and V_{mid}, and a difference between V_{mid} and the minimum value of the pulse voltage, one of the difference is larger than the other difference.

52. The liquid ejection method of claim 30, wherein diameter of an ejection opening of the nozzle is 20 μm or less.

53. The liquid ejection method of claim 52, wherein the diameter of the ejection opening of the nozzle is 8 μm or less.

54. The liquid ejection method of claim 52, wherein the diameter of the ejection opening of the nozzle is 4 μm or less.

55. A method for forming a wiring pattern of a circuit board comprising the steps of:
employing the liquid ejection method according to claim 30; and
ejecting droplets of metal paste onto the substrate.
